(19) United States
(12) Patent Application Publication
(10) Pub. No.: US 2016/0154172 A1
(43) Pub. Date: Jun. 2, 2016

(54) LIGHTING DEVICE AND DISPLAY DEVICE

(71) Applicant: SHARP KABUSHIKI KAISHA, Osaka-shi, Osaka (JP)

(72) Inventors: Masakazu KOMANO, Osaka-shi (JP); Katsutoshi KIKUCHI, Osaka-shi (JP); Kazunori MINOURA, Osaka-shi (JP); Hayato NAKAMURA, Osaka-shi (JP)

(21) Appl. No.: 14/906,009

(22) PCT Filed: Jul. 14, 2014
(86) PCT No.: PCT/JP2014/068680

§ 371 Date: Jan. 19, 2016

(30) Foreign Application Priority Data
Sep. 4, 2013 (JP) 2013-183057

(51) Int. Cl. F21V 8/00

(52) U.S. Cl. CPC G02B 6/0088; G02B 6/0055; G02B 6/0065; G02B 6/009

(57) ABSTRACT

A backlight device includes LEDs, a light guide plate, and a frame. The light guide plated includes peripheral surfaces including an LED opposing surface and an LED non-opposing surface and includes plate surfaces including a light exit surface and an opposite plate surface on the opposite side from the light exit surface. The frame includes a high light reflective portion and a high light blocking portion. The high light reflective portion is opposed to the LED non-opposing surface. The high light blocking portion is arranged such that an end of the high light reflective portion in a direction parallel to a direction from the light exit surface to the opposite plate surface along a direction normal to the plate surfaces of the light guide plate. The high light blocking portion has a lower light reflectivity and a higher light blocking property than the high light reflective portion.

### TECHNICAL FIELD

The present invention relates to a lighting device and a display device.

### BACKGROUND ART

Displays in image display devices have been shifting from conventional cathode-ray tube displays to thin displays, such as liquid crystal displays and plasma displays. With the thin displays, thicknesses of the image displaying devices can be decreased. Liquid crystal panels used in the liquid crystal display devices do not emit light. Therefore, liquid crystal display devices including liquid crystal panels require backlight units. The backlight units are classified broadly into a direct type and an edge-light type based on mechanisms. The edge-light type backlight unit includes alight source, alight source printed circuit board, and a light guide plate. The light source is mounted on the printed circuit board. The light guide plate includes a light entrance surface that is opposite the light source and through which light enters the light guide plate and a light exit surface through which light exits the light guide plate. Patent Document 1 discloses an example of a liquid crystal panel display device that includes such a backlight unit.

### RELATED ART DOCUMENT

### Patent Document

Patent Document 1: Japanese Unexamined Patent Application Publication No. 2012-59372

### Problem to be Solved by the Invention

Patent Document 1 discloses a frame that surrounds the light guide plate. The frame includes an inner frame portion and an outer frame portion. The inner frame portion is made of a white resin and formed into a rectangular frame shape. The outer frame portion is made of a black resin and formed into a rectangular frame shape. The outer frame portion surrounds peripheral surfaces of the inner frame portion. The inner frame portion reflects rays of light that leaks from the light guide plate through peripheral surfaces thereof back to the light guide plate. According to the configuration, light use efficiency improves. Furthermore, the outer frame portion absorbs rays of light out of the inner frame portion. According to the configuration, the light is less likely to leak to the outside of the frame.

Some of the rays of light that leak through the peripheral surfaces of the light guide plate may travel in directions normal to the respective peripheral surfaces of the light guide plate. Some of the rays of light may travel in directions oblique to the directions normal to the peripheral surfaces of the light guide plate and may pass through the inner frame portion. Such rays of light may not be absorbed by the outer frame portion. Namely, a leakage of light to the outer side of the frame is more likely to occur. Further, the frame is formed using a dual-color molding technique. The minimum widths are required for the inner frame portion and the outer frame portion due to production technique reasons. Thus, this configuration may not be used for the liquid crystal display device that includes a narrow frame.

### DISCLOSURE OF THE PRESENT INVENTION

The present invention was made in view of the above circumstances. An object is to reduce light leakage with a frame having a smaller size.

### Means for Solving the Problem

A lighting device of the present invention includes a light source, a light guide plate, and a frame. The light guide plate includes peripheral surfaces and plate surfaces. One of the peripheral surfaces is a light source opposing surface that is opposed to the light source and through which light from the light source enters the light guide plate. Another one of the peripheral surfaces is a light source non-opposing surface that is not opposed to the light source. One of the plate surfaces is a light exit surface through which light exits the light guide plate. Another one of the plate surfaces is an opposite plate surface on an opposite side from the light exit surface. The frame has a frame-like shape that surrounds the light guide plate. The frame includes a high light reflective portion and a high light blocking portion. The high light reflective portion is arranged at an end of the high light reflective portion in a direction parallel to a direction from the light exit surface to the opposite plate surface along a normal direction that is a direction normal to the plate surfaces of the light guide plate. The high light blocking portion has light reflectivity lower than that of the high light reflective portion. The high light reflective portion has a light blocking property higher than that of the high light reflective portion.

According to this configuration, light from the light source enters the light guide plate through the light source opposing surface, travels inside the light guide plate, and exits the light guide plate through the light exit surface. Light that travels inside the light guide plate may leak out through the light source non-opposing surface, which is one of the peripheral surfaces not opposite the light source. Even in such a case, the light that leaks from the light guide plate is efficiently reflected back to the light source non-opposing surface by the high light reflective portion of the frame that surrounds the light guide plate. The high light reflective portion that is opposite at least the light source non-opposing surface of the light guide plate has a higher light reflectivity than the high light blocking portion. According to this configuration, light use efficiency remains high.

The high light reflective portion has a higher light reflectivity than the high light blocking portion but has a lower light blocking property than the high light blocking portion. Therefore, light tends to pass through the high light reflective portion and the light that passes therethrough may leak to the outside of the high light reflective portion. However, the high light blocking portion that is closer to the light exit surface than the opposite plate surface of the light guide plate in the normal direction normal to the plate surfaces of the light guide plate has a light blocking property higher than that of the high light reflective portion. Therefore, even when light passes through the high light reflective portion, the high light blocking portion appropriately blocks the light. In particular, even when light that leaks through the light source non-opposing surface travel in directions oblique to the normal direction normal to the light source non-opposing surface and pass through the high light reflective portion, the high light blocking portion that is closer to the light exit surface than the opposite plate surface of the light guide plate in the normal direction normal to the plate surfaces of the light guide plate preferably blocks the light. Namely, leakage of light to the outside is preferably suppressed. Furthermore, the high light reflective portion and the highlight blocking portion are arranged in the normal direction normal to the plate surface of the light guide plate. According to this configuration, the frame that may have a small width is less likely to be subject to manufacturing constraints. Therefore, the frame 16 can be easily produced using the dual-color molding technique. That is, this configuration is preferable to reduce the frame size of the backlight device.

The following configurations of the lighting device according to the present invention are preferable.

(1) The lighting device may further include an optical sheet including a plate surface that extends along the plate surfaces of the light guide plate and faces the light exit surface of the light guide plate. The high light blocking portion may have a light absorbing property higher than the high light reflective portion. The high light blocking portion is arranged such that at least a portion of a surface thereof along the normal direction normal to the plate surfaces of the light guide plate is opposite to a peripheral surface. According to this configuration, the high light blocking portion having a higher light absorbing property than the high light reflective portion preferably absorbs light that transmits through the high light reflective portion. Namely, light is less likely to be reflected by the surface of the high light blocking portion. Furthermore, since the high light blocking portion is arranged such that at least a portion of the surface thereof along the normal direction normal to the plate surfaces of the light guide plate is opposed to the peripheral surface of the optical sheet. According to this configuration, light reflected by the high light blocking portion is less likely to enter the optical sheet through the peripheral surface of the optical sheet. Thus, uneven brightness is less likely to occur in light that exits the lighting device.

(2) The high light reflective portion may include an opposite surface that is opposed to the light source non-opposing surface of the light guide plate. The high light reflective portion being arranged such that the opposite surface thereof may be flush with the peripheral surface of the optical sheet or closer to the light source non-opposing surface relative to the peripheral surface of the optical sheet. According to this configuration, when light that leaks from the light guide plate through the light source non-opposing surface is reflected by the high light reflective portion, the light that is reflected is efficiently returned to the light source non-opposing surface. Thus, the light that is reflected is less likely to enter the optical sheet through the peripheral surface thereof. Namely, light use efficiency is further improved and uneven brightness is further less likely to occur in light that exits the lighting device.

(3) The lighting device may further include a chassis that holds the light source, the light guide plate, and the frame therein. The chassis may include at least a bottom plate and a peripheral wall. The bottom plate may extend along one of the plate surfaces of the light guide plate. The peripheral wall that extends upward from an edge of the bottom plate may surround the frame. The high light blocking portion may include a peripheral-wall overlapping portion disposed on an end of the peripheral wall in in the direction parallel to a direction from the opposite plate surface to the light exit surface along the normal direction normal to the plate surfaces of the light guide plate. According to this configuration, the width of the high light blocking portion increases by the size of the peripheral wall overlapping portion. Thus, light that passes through the high light reflective portion is more properly blocked and light leakage is more preferably suppressed.

(4) The high light reflective portion may be arranged such that at least a portion of a surface thereof along the normal direction normal to the plate surface of the light guide plate is opposed to the light source. A large amount of light inside the light guide plate tends to travel through a portion that is located corresponding to the light source in the direction normal to the plate surface of the light guide plate. With the highlight reflective portion arranged corresponding to the light source in the direction normal to the plate surfaces of the light guide plate, light that leaks from the light guide plate through the light source non-opposing surface is efficiently reflected back to the light source non-opposing surface. Therefore, the light use efficiency further increases.

(5) The high light reflective portion may be arranged such that an entire area of a surface thereof along the normal direction normal to the plate surface of the light guide plate is opposed to the light source non-opposing surface. According to this configuration, namely, the configuration that the entire area of the high light reflective portion in the normal direction normal to the plate surfaces of the light guide plate is opposite the light source non-opposing surface, light that leaks from the light guide plate through the light source non-opposing surface is efficiently reflected back to the light source non-opposing surface by the high light reflective portion. Thus, light use efficiency further improves.

(6) The high light reflective portion and the high light blocking portion of the frame are integrally formed by dual-color molding. According to this configuration, since the high light reflective portion and the high light blocking portion are arranged in the normal direction normal to the plate surfaces of the light guide plate, the frame can be easily prepared using the dual-color molding technique even if the frame is restricted to have a small width. Therefore, this configuration is preferable to reduce the size of the frame.

(7) The frame may include a large-width portion having a relatively large width and a small-width portion having a relatively small width. The small-width portion may be on an end of the large-width portion in the direction parallel to the direction from the opposite surface to the light exit surface along the normal direction normal to the plate surfaces of the light guide plate. The large-width portion may constitute the high light reflective portion and the small-width portion may constitute the high light blocking portion. According to this configuration, the position of the boundary between the large-width portion and the small-width portion matches the position of the boundary between the high light reflective portion and the high light blocking portion. Thus, a die for a secondary molding used during dual-color molding process can have a simple structure.

(8) The large-width portion may be closer to the light source non-opposing surface of the light guide plate relative to the small-width portion. According to this configuration, light that leaks from the light guide plate through the light source non-opposing surface is further efficiently reflected by the high light reflective portion, that is, by the large-width portion.

(9) The lighting device may include a light source board on which the light source is mounted. The light source board may be arranged such that at least a portion of a surface thereof along the normal direction normal to the plate surfaces of the light guide plate is opposed to the high light blocking portion with space between the light source board and the high light blocking portion. The frame may include a light source supporting portion for supporting at least a portion of an end of the light source board in the direction parallel to the direction from the light exit surface to the opposite plate surface along the normal direction normal to the plate surfaces of the light guide plate. The light source supporting portion may be along the light source opposing surface. The high light blocking portion of the frame adjacent to the light source opposing surface may include an extending portion extending toward the light source board supporting portion, the high light blocking portion extending along the light source non-opposing surface, and the light source board includes a cut portion to receive the extending portion. A gap is in between the light source board and the high light blocking portion that are opposed to each other along the normal direction normal to the plate surface of the light guide plate. Therefore, light may leak out through the gap. However, the bar portion along the light source non-opposing surface that is adjacent to the light source opposing surface of the light guide plate includes the high light blocking portion and the high light blocking portion may include the extending portion that extends toward the light source board supporting portion that supports the light source board. Furthermore, the light source board includes the cut portion that receives the extending portion. In this configuration, the gap between the light source board and the high light blocking portion is less likely to extend straight in a view from the normal direction of the plate surface of the light guide plate. Therefore, even if light leaks through the gap, the amount of the light that leaks therethrough reduces.

(10) The extending portion and the cut portion may be formed such that edges thereof adjacent to each other are oblique when viewed in the direction normal to the plate surfaces of the light guide plate. According to this configuration, the light source board does not include a right angled corner corresponding to the cut portion. Thus, stress is less likely to concentrate at a portion of the light source board and thus breakage of the light source board is less likely to occur.

To solve the above problem, a display device according to this invention may include the lighting device and a display device configured to display an image using light from the lighting device.

According to the display device, since the display device includes the lighting device that appropriately suppress light leakage with the frame having a small size, the displaying performance of the display device is improved with the frame having a small size.

The following configurations of the lighting device according to the present invention are preferable.

(1) The frame is arranged such that the high light blocking portion thereof supports the display panel from a side of the display panel close to the light guide plate. According to this configuration, when light leaks from the light guide plate through the light source non-opposing surfaces and passes through the high light reflective portion, the light that passes through the high light reflective portion is blocked by the high light blocking portion. That is, the light that passes through the high light reflective portion is less likely to enter the display panel. Thus, the quality of images displayed on the display panel improves.

(2) The display panel may be a liquid crystal display panel using liquid crystals. Such a display device can be used as a liquid crystal display device for many applications such as displays of portable information terminals such as smart phones and tablet-type personal computers.

### Advantageous Effect of the Invention

According to the present invention, light leakage is reduced with a frame having a smaller size.

### BRIEF DESCRIPTION OF THE DRAWINGS

FIG. 1 is an exploded perspective view of a liquid crystal display device according to a first embodiment.

FIG. 2 is a plan view of a backlight device included in the liquid crystal display device.

FIG. 3 is a cross-sectional view of the liquid crystal display device cut along line iii-iii in FIG. 2.

FIG. 4 is a cross-sectional view of the liquid crystal display device cut along line iv-iv in FIG. 2.

FIG. 5 is a magnified plan view of the backlight device illustrating corners on an edge thereof close to an LED board.

FIG. 6 is a cross-sectional view of a liquid crystal display device according to a second embodiment illustrating cross sections of long edges thereof.

FIG. 7 is a magnified plan view of a backlight device included in a liquid crystal display device according to a third embodiment illustrating corners on an end of the backlight device close to an LED board.

FIG. 8 is a magnified plan view of a backlight device included in a liquid crystal display device according to a fourth embodiment illustrating corners on an end of the backlight device close to an LED board.

FIG. 9 is a magnified plan view of a backlight device included in a liquid crystal display device according to a fifth embodiment illustrating corners on an end of the backlight device close to an LED board.

FIG. 10 is a cross-sectional view of a liquid crystal display device according to a sixth embodiment illustrating cross sections of long edges thereof.

FIG. 11 is a cross-sectional view of a liquid crystal display device according to a seventh embodiment illustrating cross sections of long edges thereof.

FIG. 12 is a cross-sectional view of a liquid crystal display device according to an eighth embodiment illustrating cross sections of long edges thereof.

FIG. 13 is a cross-sectional view of a liquid crystal display device according to a ninth embodiment illustrating cross sections of long edges thereof.

FIG. 14 is a cross-sectional view of a liquid crystal display device according to a tenth embodiment illustrating cross sections of long edges thereof.

FIG. 15 is an exploded cross-sectional view of a frame according to an eleventh embodiment.

FIG. 16 is an exploded cross-sectional view of a frame according to a twelfth embodiment.

FIG. 17 is a cross-sectional view of a liquid crystal display device according to a thirteenth embodiment illustrating portions close to long edges thereof.

### MODE FOR CARRYING OUT THE INVENTION

### First Embodiment

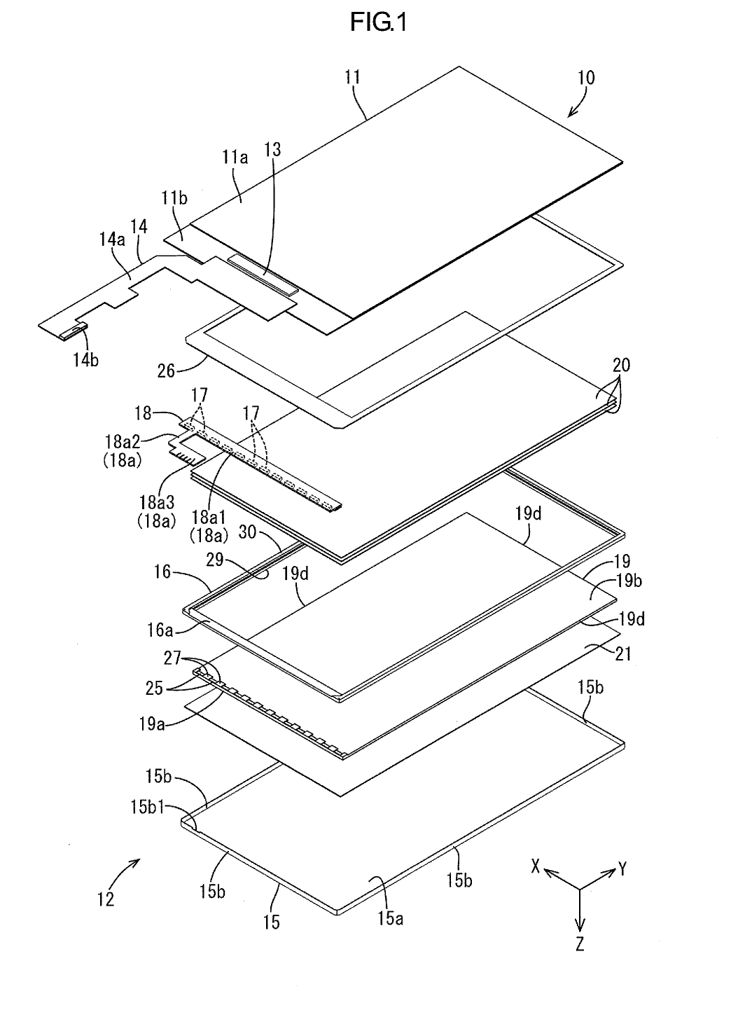

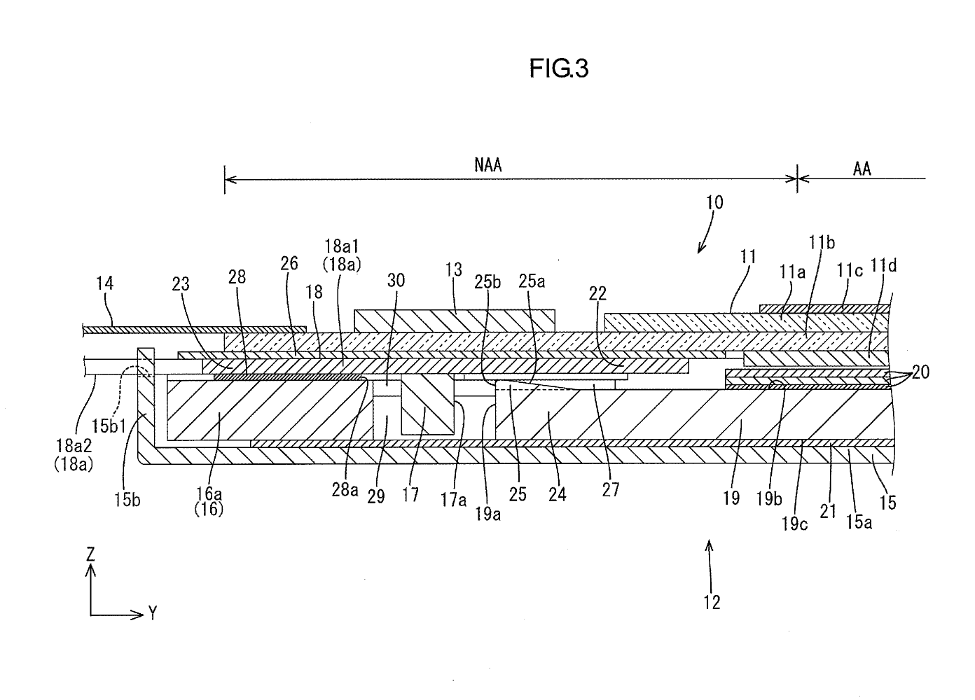

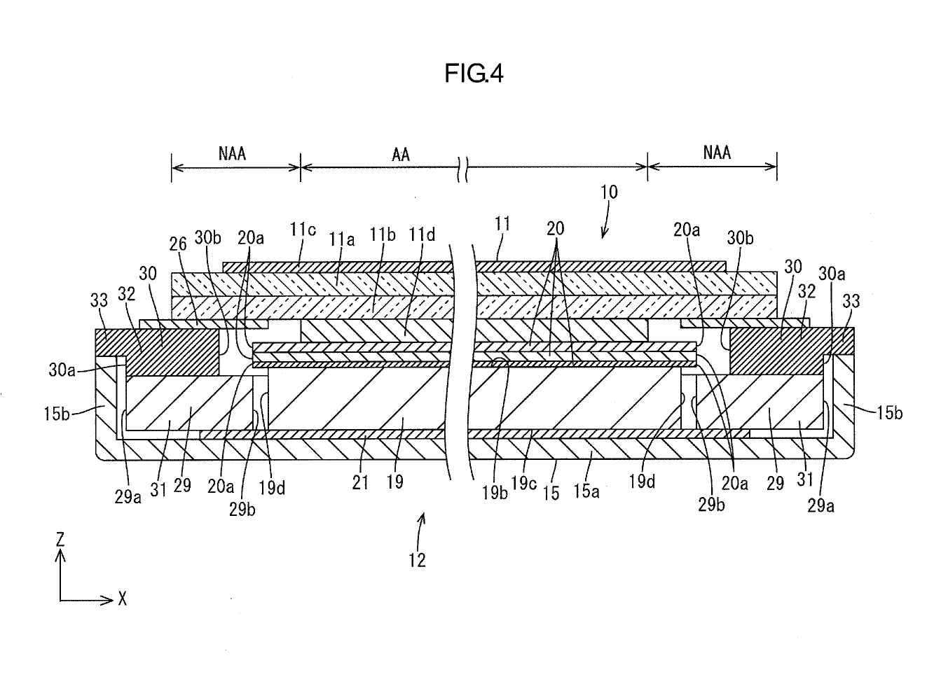

A first embodiment will be described with reference to FIGS. 1 to 5. A liquid crystal display device (a display device) 10 including a liquid crystal panel 11 as a display panel will be described in this description. X-axis, Y-axis and Z-axis may be indicated in the drawings. The axes in each drawing correspond to the respective axes in other drawings. The vertical direction in FIGS. 3 and 4 is defined as a reference. The upper side and the lower side in FIGS. 3 and 4 correspond to the front side and the rear side, respectively.

As illustrated in FIG. 1, the liquid crystal display device 10 has a rectangular overall shape. The liquid crystal display device 10 includes the liquid crystal panel (a display panel) 11 and a backlight device (a lighting device) 12 as an external light source. The liquid crystal panel 11 displays images. The backlight device 12 is on the rear side of the liquid crystal panel 11 and configured to provide light to the liquid crystal panel 11. On the front side of the liquid crystal panel 11, an unillustrated frame member may be arranged to sandwich and hold an outer portion of the liquid crystal panel 11 (a non-display area NAA, which will be described later) between the frame member and the backlight device 12. Alternatively, an unillustrated touch panel or an unillustrated cover panel may cover a front surface of the liquid crystal panel 11. The liquid crystal display device 10 according to this embodiment is used in portable electronic devices such as smart phones and tablet personal computers. The display size of the liquid crystal panel 11 is from four inches to 20 inches.

The liquid crystal panel 11 will be described. As illustrated in FIGS. 1 and 3, the liquid crystal panel 11 has a rectangular overall shape in a plan view. The liquid crystal panel 11 includes a pair of transparent glass boards 11a, 11b (having light transmissivity) and a liquid crystal layer (not illustrated) in between the boards 11a and 11b. The liquid crystal layer contains liquid crystal molecules, which are substances that change optical characteristics when electromagnetic field is applied. The boards 11a, 11b are bonded together with a sealing agent (not illustrated) with a gap therebetween. The gap corresponds to a thickness of the liquid crystal layer. The liquid crystal panel 11 has a display area (an active area) AA and a non-display area (a non-active area) NAA (see FIGS. 3 and 4). The display area AA displays images. The non-display area NAA is around the display area AA and has a frame-like shape (or a picture frame-like shape). A short-side direction and a long-side direction of the liquid crystal panel 11 correspond to the X-axis direction and the Y-axis direction, respectively. A thickness dimension of the liquid crystal panel 11 corresponds to the Z-axis direction.

One of the boards 11a, 11b on the front (a front-surface side) is a CF board 11a. The other one of the boards 11a, 11b on the rear (a rear-surface side) is an array board 11b. As illustrated in FIGS. 1 and 3, the array board 11b has a long dimension that is longer than a long dimension of the CF board 11a. One of short ends of the CF board 11a is aligned with a corresponding short end of the array board 11b. The other short end of the array board 11b extends outward over the other short end of the CF board 11a. A driver 13 (a panel driving portion) for driving the liquid crystal panel 11 and a flexible printed circuit board 14 for providing various signals to the driver 13 are mounted on a portion of the array board 11b located outside of the edge of the CF board 11a. The driver 13 is directly mounted on the above-described edge portion of the array board 11b using chip on glass (COG) technology. The driver 13 is configured to receive various signals transmitted from an unillustrated panel driving circuit via the flexible printed circuit board 14, process the various signals, and send the signals that are processed to a switching element, which will be described later, in the display area AA. Polarizing plates 11c and 11d are bonded on outer surfaces of the respective boards 11a and 11b.

Internal configurations of the display area AA of the liquid crystal panel 11 (not illustrated) will be described in detail. A number of thin film transistors (TFTs), which are switching components, and a number of pixel electrodes are arranged in a matrix on an inner surface of the array board 11b (on the liquid crystal layer side, a side opposed to the CF board 11a). Gate lines and source lines are routed in a grid so as to surround the TFTs and the pixel electrodes. Specific image signals are supplied from the driver 13 to the gate lines and the source lines. Each pixel electrode surrounded by the gate lines and the source lines is a transparent electrode of indium tin oxide (ITO) and zinc oxide (ZnO).

On the CF board 11a, a number of color filters are disposed at positions corresponding to pixels. The color filters are arranged such that three colors of R, G and B are repeatedly arranged. Between the color filters, a light blocking layer (a black matrix) is formed for reducing color mixture. Counter electrodes that are opposed to the pixel electrodes on the array board 11b are on surfaces of the color filters and the light blocking layer. The CF board 11a is slightly smaller than the array board 11b. On the inner surfaces of the boards 11a and 11b, alignment films for alignment of liquid crystal molecules in the liquid crystal layer are formed, respectively.

As illustrated in FIGS. 1 and 3, the flexible printed circuit board 14 is connected to the liquid crystal panel 11 such that an end portion of the flexible printed circuit board 14 is connected to the portion of the array board 11b located outward with respect to the CF board 11a. Another end portion of the flexible printed circuit board 14 is connected to a panel driving circuit board, which is not illustrated. The flexible printed circuit board 14 includes at least a base member 14a, a terminal (not illustrated), and a connector 14b. The base member 14a that has an L-like overall shape in a plan view is a film-like member having flexibility. The terminal is at one end portion of the base member 14a (the end portion close to the liquid crystal panel 11). The connector 14b is at another end portion of the base member 14a (the end portion close to the panel driving circuit board). The terminal is electrically and mechanically connected to a panel side terminal that is at the short end of the array board 11b via anisotropic conductive films (ACF). The base member 14a includes a portion that extends from the one end portion thereof including the terminal beyond the backlight device 12 in the Y-axis direction. The portion of the base member 14b is folded toward the rear to have a substantially U shape and thus the connector 14b at the other end portion of the base member 14a is fitted in a circuit board side connector (not illustrated) which is at the panel driving circuit board on the rear of the backlight device 12.

Configurations of the backlight device 12 will be described in detail. The backlight device 12 has a rectangular block-like overall shape in a plan view, similar to the liquid crystal panel 11. As illustrated in FIGS. 1 to 3, the backlight device 12 includes at least a chassis (a casing, a housing) 15, a frame 16, the LEDs (Light Emitting Diode) 17 as a light source, an LED printed circuit board (a light source printed circuit board) 18, a light guide plate 19, an optical sheet (an optical member) 20, and a reflection sheet (a reflection member) 21. The chassis 15 has a tray-like shape having an opening on the liquid crystal panel 11 side. The frame 16 is disposed in the chassis 15. The LEDs 17 are mounted on the LED printed circuit board 18. The light guide plate 19 is configured to guide light from the LEDs 17. The optical sheet 20 is placed on the front of the light guide plate 19. The reflection sheet 21 is placed on the rear of the light guide plate 19. In the backlight device 12, the LEDs 17 (or the LED printed circuit board 18) are disposed close to one of short sides of the liquid crystal panel 11. Namely, the backlight device 12 is a single edge light type (or a side-light type) backlight in which light enters the light guide plate 19 only through one side of the light guide plate 19. Components of the backlight device 12 will be described.

The chassis 15 is formed from a metal plate, which may be an aluminum plate or an electro galvanized steel plate (SECC). As illustrated in FIGS. 1 to 3, the chassis 15 includes a bottom plate 15a and peripheral walls 15b. The bottom plate 15a has a rectangular plate-like shape in a plan view similar to the liquid crystal panel 11. The peripheral walls 15b extend from corresponding edges of the bottom plate 15a (two long edges and two short edges) toward the front side. A long-side direction and a short-side direction of the chassis 15 (the bottom plate 15a) correspond to the Y-axis direction and the X-axis direction, respectively. Plate surfaces of the bottom plate 15a are parallel to plate surfaces of each of the liquid crystal panel 11, the light guide plate 19, and the optical sheet 20. On one of the plate surfaces of the bottom plate 15a on the rear side, printed circuit boards including the panel driving printed circuit board and the LED driving circuit board, which are not illustrated, are mounted. The peripheral walls 15b form a rectangular portrait overall frame-like shape that surrounds the frame 16 along a periphery of the frame 16. One of the four peripheral walls 15b overlaps the portion of the flexible printed circuit board 14 extending to the outside of the backlight device 12 (one of the peripheral walls 15b on the short side or near side in FIG. 1). The one of the peripheral walls 15b includes a cut portion 15b1 through which the LED printed circuit board 18 extends to the outside. The LED printed circuit board 18 will be described later.

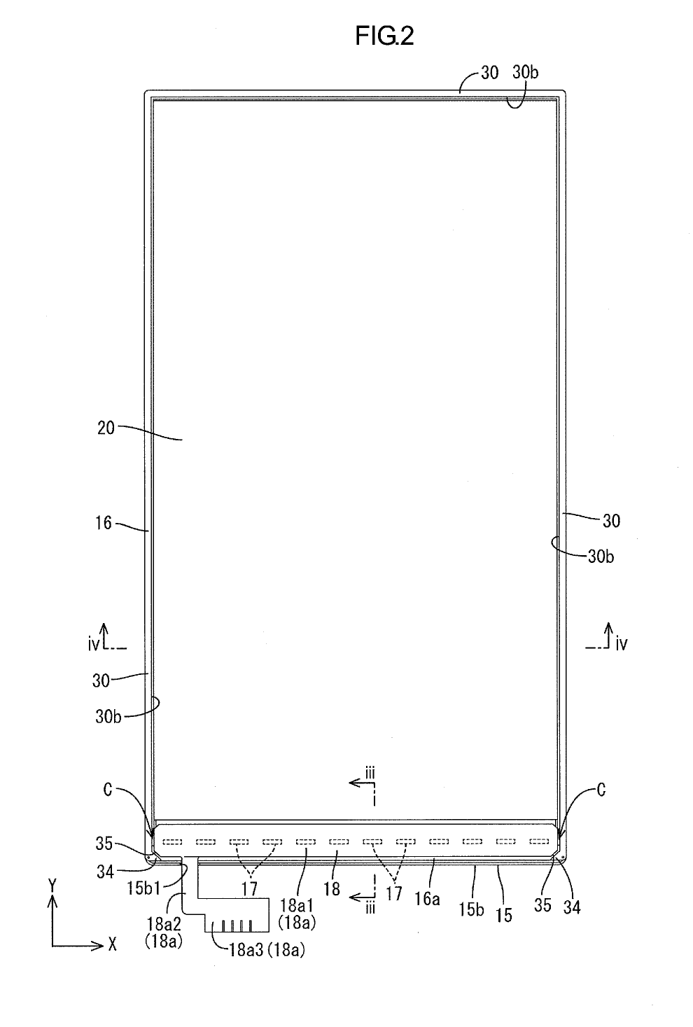

The frame 16 is made of synthetic resin. As illustrated in FIGS. 1 and 2, the frame 16 has a frame-like overall shape that is slightly smaller than the chassis 15 but slightly larger than the light guide plate 19. The frame 16 is disposed in the chassis 15 and surrounded by the four peripheral walls 15b of the chassis 15. The frame 16 surrounds the light guide plate 19 along peripheral surfaces of the light guide plate 19. The frame 16 has a rectangular overall shape in a plan view (when viewed from a point in a normal direction normal to plate surfaces of the light guide plate 19). The frame 16 includes two short-bar portions extending in the X-axis direction and two long-bar portions extending in the Y-axis direction. The short-bar portions and the long-bar portions continue to one another. As illustrated in FIGS. 2 and 3, one of the short-bar portions of the frame 16 overlaps a main board portion 18a1 of the LED printed circuit board 18 in a plan view, which will be described later. The one of the short-bar portions is defined as an LED board supporting portion 16a. The LED board supporting portion 16a supports the main board portion 18a1 from the rear side (i.e., a side of the main board portion 18a1 at an end thereof in a direction parallel to a dimension of the light guide plate 19 from a light exit surface 19b to an opposite plate surface 19c and the normal direction that is normal to the plate surfaces of the light guide plate 19). The LED board supporting portion 16a is disposed such that at least a portion of a surface thereof along the Z-axis direction (in the normal direction normal to the plate surfaces of the light guide plate 19) is opposed to an LED opposing surface 19a of the light guide plate 19 and the LEDs 17. The LEDs 17 are disposed between the LED board supporting portion 16a and the LED opposing surface 19a of the light guide plate 19 in the Y-axis direction (a normal direction normal to the LED opposing surface 19a). The LED board supporting portion 16a of the frame 16 has a relatively larger width and a relatively smaller thickness (i.e., the height, namely, a dimension in the Z-axis direction) than those of other three bar portions of the frame 16 (the two long-bar portions and the other one of the short-bar portions on an opposite side from the LED board supporting portion 16a). Details of the three bar portions of the frame 16 other than the LED board supporting portion 16a will be described later.

As illustrated in FIGS. 1 to 3, each LED 17 includes an LED chip (an LED element), which is a semiconductor light emitting element, disposed on a board and sealed with a resin. The board is fixed to a plate surface of the LED printed circuit board 18. The LED chip mounted on the board has one main wavelength of emitting light. Specifically, the LED chip that emits light in a single color of blue is used. In the resin that seals the LED chip, phosphors that emit a certain color of light when excited by the blue light emitted by the LED chip are dispersed. An overall color of light emitted by the phosphors is substantially white. The LED 17 includes a light emitting surface 17a that is one of side surfaces thereof adjacent to a surface of the LED 17 mounted on the LED printed circuit board 18. That is, the LEDs 17 are so-called side-emitting type LEDs.

As illustrated in FIGS. 1 to 3, the LED printed circuit board 18 includes a base member (a base member) 18a that is a film-like member (or a sheet-like) made of an insulating material and having flexibility. Plate surfaces of the LED printed circuit board 18 are parallel to the plate surfaces of the liquid crystal panel 11, the light guide plate 19, and the optical sheet 20. On a rear surface of the base member 18a (a plate surface opposite from a surface facing the liquid crystal panel 11, a plate surface facing the frame 16 and the light guide plate 19), the LEDs 17 are mounted and traces (not illustrated) for transmitting power to the LEDs 17 are formed by patterning. As illustrated in FIG. 3, the LED printed circuit board 18 is disposed on the front of the frame 16 and the light guide plate 19 in the Z-axis direction. The LED printed circuit board 18 is sandwiched between the liquid crystal panel 11, and the frame 16 and the light guide plate 19. As illustrated in FIGS. 1 and 2, the base member 18a of the LED printed circuit board 18 includes a main board portion 18a1, an extended portion 18a2, and an external connecting portion 18a3. The main board portion 18a1 extends along the short-side direction (X-axis direction) of the backlight device 12. The extended portion 18a2 extends outward in the Y-axis direction (away from the light guide plate 19) from one of edges of the main board portion 18a1. The external connecting portion 18a3 to be connected the LED driving circuit board is at a distal end of the extended portion 18a2. Similar to the base member 14a of the flexible printed circuit board 14, the extended portion 18a2 is out of the chassis 15 and is folded toward the rear of the chassis 15 to have a substantially U shape. The external connecting portion 18a3 at the distal end of the extended portion 18a2 is connected to the LED driving circuit board on the rear of the chassis 15.

As illustrated in FIGS. 1 and 2, the main board portion 18a1 has a landscape-rectangular shape in a plan view. The length (the long-side dimension) of the main board portion 18a1 is substantially equal to or slightly larger than the short-side dimension of the light guide plate 19, which will be described later. The width (the short-side dimension) of the main board portion 18a1 is larger than a distance (or a space) between the LED opposing surface 19a of the light guide plate 19 and the LED board supporting portion 16a of the frame 16. The main board portion 18a1 includes a light guide plate overlapping portion 22 and a frame overlapping portion 23. The light guide plate overlapping portion 22 is one of edge portions of the width dimension (the short-side dimension, the Y-axis dimension) of the main board portion 18a1. The light guide plate overlapping portion 22 overlaps a portion of the light guide plate 19 (a light entrance edge portion 24, which will be described later) in a plan view. The frame overlapping portion 23 is the other edge portion of the main board portion 18a1. The frame overlapping portion 23 overlaps the LED board supporting portion 16a of the frame 16 in a plan view. A portion of the main board portion 18a1 between the light guide plate overlapping portion 22 and the frame overlapping portion 23 is an LED mounting portion on which the LEDs 17 are mounted. The LEDs 17 (ten LEDs in FIGS. 1 and 2) are arranged at intervals along a length direction of the main board portion 18a1 (the X-axis direction) and connected in series by the traces. Intervals between the adjacent LEDs 17 are substantially constant, that is, the LEDs 17 are arranged at equal intervals in the X-axis direction.

As illustrated in FIGS. 1 and 3, the LED printed circuit board 18 and the frame 16 are fixed to the liquid crystal panel 11 with a panel fixing member 26. The panel fixing member 26 has a rectangular frame-like shape in a plan view, similar to the frame 16. The panel fixing member 26 includes a base board that has black-colored surfaces and thus the panel fixing member 26 has light blocking properties. An adhesive agent is applied on surfaces of the panel fixing member 26. One of short-bar portions of the panel fixing member 26 overlaps the LED printed circuit board 18 in a plan view. The one of the short-bar portions has a relatively larger width. Other three bar portions of the panel fixing member 26 have a relatively smaller width. The one of the short-bar portions having a larger width is fixed to a front plate surface of the LED printed circuit board 18 and a rear plate surface of the liquid crystal panel 11. The other three bar portions having a smaller width are fixed to front surfaces of the corresponding bar portions of the frame 16 (the bar-portions except the LED board supporting portion 16a) and the rear plate surface of the liquid crystal panel 11.

As illustrated in FIGS. 1 and 3, the light guide plate 19 has a rectangular shape that is slightly smaller than inner dimensions of the frame 16 in a plan view. Plate surfaces of the light guide plate 19 are parallel to the plate surfaces of each of the liquid crystal panel 11, the bottom plate 15a of the chassis 15, and the optical sheet 20. A long-side direction and a short-side direction of the plate surface of the light guide plate 19 correspond to the Y-axis direction and the X-axis direction, respectively. A thickness direction of the light guide plate 19 perpendicular to the plate surfaces of the light guide plate 19 corresponds to the Z-axis direction. In the chassis 15, the light guide plate 19 is arranged immediately below the liquid crystal panel 11 and the optical sheet 20. The periphery of the light guide plate 19 is surrounded by the frame 16. The light guide plate 19 includes peripheral surfaces. One of short-side peripheral surfaces of the light guide plate 19 on the left in FIG. 3 is opposite the LEDs 17 and defined as the LED opposing surface (a light source opposing surface) 19a. Light from the LEDs 17 enters the light guide plate 19 through the LED opposing surface 19a. Other three peripheral surfaces (the short-side surface on the right in FIG. 3 and two long-side surfaces) are not opposite the LEDs 17 and defined as LED non-opposing surfaces (a light source non-opposing surface) 19d. The LED opposing surface 19a is configured as a light entrance surface through which light emitted by the LEDs 17 enters the light guide plate 19, whereas the LED non-opposing surfaces 19d are not configured as surfaces through which light emitted by the LEDs 17 directly enters. The light guide plate 19 includes two long-side edge portions and two short-side edge portions. One of the short-side edge portions of the light guide plate 19 close to the LED opposing surface 19a is a light entering edge portion 24. The light entering edge portion 24 is away from the LED board supporting portion 16a of the frame 16 with the LEDs 17 in between. The one of the plate surfaces of the light guide plate 19 facing the front (facing the liquid crystal panel 11) is a light exit surface 19b through which light exits the light guide plate 19 toward the liquid crystal panel 11. The other plate surface of the light guide plate 19 facing the rear is the opposite plate surface 19c that is on the opposite side from the light exit surface 19b. In this configuration, an arrangement direction in which the LED 17 and the light guide plate 19 are arranged corresponds to the Y-axis direction. Further, an arrangement direction in which the optical sheet 20 (or the liquid crystal panel 11) and the light guide plate 19 are arranged corresponds to the Z-axis direction. These arrangement directions are perpendicular to each other. The light guide plate 19 is configured to receive light that travels from each LED 17 in the Y-axis direction through the LED opposing surface 19a, to transmit the light therethrough, and to direct the light toward the optical sheet 20 (the front side, the light exit side). Light exits the light guide plate 19 through the light exit surface 19b, which is the front plate surface of the light guide plate 19.

As illustrated in FIG. 3, the light entering edge portion 24 of the light guide plate 19 includes light entering area extended portions 25. The light entering area extended portions 25 project from portions of the light exit surface 19b toward the light guide plate overlapping portion 22 of the LED printed circuit board 18. Each light entering area extended portion 25 has a substantially right-angled triangular cross section and has a sloped surface 25a on an opposite side from the LED opposing surface 19a. That is, the light entering area extended portion 25 projects such that a dimension thereof projecting from the light exit surface 19b gradually increases as a distance to the LEDs 17 (the LED opposing surface 19a) decreases and the dimension thereof gradually decreases as the distance to the LEDs 17 increases. The light entering area extended portion 25 includes another surface on the opposite side from the sloped surface 25a. The surface is defined a light entering extended surface 25b. The light entering extended surface 25b is flush with the LED opposing surface 19a. Further, the light entering extended surface 25b is opposite the LEDs 17 and thus rays of light from the LEDs 17 enter the light guide plate 19 through the extended light entering surfaces 25b. According to this configuration, the light guide plate 19 has a larger area through which rays of light from the LEDs 17 enter and thus light entering efficiency improves. Namely, this configuration is effective for increasing brightness and reducing power consumption. The light entering area extending portions 25 are arranged at intervals in the X-axis direction on the light entering edge portion 24 such that the light entering area extended portions 25 are located correspond to the respective LEDs 17 in the X-axis direction. The light guide plate 19 further includes projections 27 that project from portions of the light entering edge portion 24 other than the portions including the light entering area extending portions 25. The projections 27 project from portions of the light exit surface 19b toward the front. Distal end surfaces of the projections 27 are substantially flat. The projections 27 are arranged at intervals in the X-axis direction.

As illustrated in FIG. 3, the frame 16 and the light guide plate 19 are fixed to the LED printed circuit board 18 with an LED board fixing member 28. The LED board fixing member 28 has a rectangular shape that extends in the X-axis direction, similar to the main board portion 18a1 of the LED printed circuit board 18. The LED board fixing member 28 includes a base member having a film-like shape. On surfaces of the base member, adhesive agents are applied. One of surfaces of the LED board fixing member 28 on the front side is fixed to the main board portion 18a1 of the LED printed circuit board 18. The other surface of the LED board fixing member 28 on the rear side is attached to the LED board supporting portion 16a of the frame 16 and the projections 27 of the light entering edge portion 24 of the light guide plate 19. The LED board fixing member 28 has openings 28a at positions corresponding to the LEDs 17 and the light entering area extending portions 25 so that the LEDs 17 and the light entering area extending portions 25 are passed through the openings 28a.

As illustrated in FIGS. 1 and 3, the optical sheet 20 has a rectangular shape in a plan view similar to the light guide plate 19. Plate surfaces of the optical sheet 20 are parallel to the plate surfaces of each of the liquid crystal panel 11, the bottom plate 15a of the chassis 15, and the light guide plate 19. A long-side direction and a short-side direction of the plate surface of the optical sheet 20 correspond to the Y-axis direction and the X-axis direction, respectively. A thickness direction of the optical sheet 20 perpendicular to the plate surfaces of the optical sheet 20 corresponds to the Z-axis direction. The optical sheet 20 is placed on the light exit surface 19b of the light guide plate 19 and is located between the liquid crystal panel 11 and the light guide plate 19. The optical sheet 20 is configured to pass light from the light guide plate 19, to add specific optical effects to the light, and to direct the light toward the liquid crystal panel 11. The optical sheet 20 includes peripheral surfaces including short-side surfaces. As illustrated in FIG. 3, one of short-side surfaces close to the LEDs 17 (a light source side surface) is located on the inner side (on a side away from the LEDs 17) with respect to the LED opposing surface 19a of the light guide plate 19. As illustrated in FIG. 4, other three side surfaces of the optical sheet 20 are located outside (close to the frame 16) with respect to the corresponding LED non-opposing surfaces 19d of the light guide plate 19. Each of the three side surfaces is defined as an LED non-arranged side surface (a light source empty side surface) 20a. FIG. 4 is a cross-sectional view of the backlight device 12 illustrating cross-sectional configurations of long-edge ends thereof. The edge of the liquid crystal display device 10 on the upper side in FIG. 2 has similar cross-sectional configurations to those in FIG. 4. The optical sheet 20 includes multiple sheet members that are placed on one another (three in this embodiment). Examples of the optical sheet 20 include a diffuser sheet, a lens sheet, and a reflecting type polarizing sheet. The optical sheets may be selected from those as appropriate.

As illustrated in FIGS. 1 and 3, the reflection sheet 21 covers the opposite plate surface 19c of the light guide plate 19, which is the rear surface or a surface opposite from the light exit surface 19b of the light guide plate 19. The reflection sheet 21 is a rectangular sheet member made of synthetic resin with a white surface having high light reflectivity. With the reflection sheet 21, rays of light traveling through the light guide plate 19 are effectively directed toward the front (toward the light exit surface 19b). The reflection sheet 21 has a rectangular shape in a plan view, similar to the light guide plate 19. A central portion of the reflection sheet 21 is sandwiched between the light guide plate 19 and the chassis 15. As illustrated in FIGS. 3 and 4, an outer portion of the reflection sheet 21 overlaps the frame 16 in a plan view. The outer portion is sandwiched between the frame and the bottom plate 15a of the chassis 15. That is, the reflection sheet 21 include a portion that extends from the LED opposing surface 19a of the light guide plate 19 to the LED board supporting portion 16a of the frame 16. With the portion that extends, light from the LEDs 17 are effectively directed to the LED opposing surface 19a.

Rays of light that transmits inside the light guide plate 19 may leak out through the LED non-opposing surfaces 19d that are not opposite the LEDs 17. To reduce such a light leakage, a conventional frame may include an inner frame portion and an outer frame portion. The inner frame portion is made of a white resin and formed into a rectangular frame shape. The outer frame portion is made of a black resin and formed into a rectangular frame. The outer frame portion surrounds peripheral surfaces of the inner frame portion. However, while some rays of the light that leaks through the LED non-opposing surfaces 19d travel in directions normal to the respective LED non-opposing surfaces 19d, other rays of the light travel toward the front at angles with respect to the normal directions. The rays of light that travel in the oblique directions oblique to the front may pass through the inner frame portion. In such a case, the outer frame portion may not absorb the rays of light and thus the rays of light may leak to the outside through the non-display area NAA of the liquid crystal panel 11. The rays of light through the non-display area NAA of the liquid crystal panel 11 may degrade the quality of images displayed in the display area AA of the liquid crystal panel 11. Further, the conventional frame may be formed using a dual-color molding technique. Due to production technical reasons, certain widths are required for each of the inner frame portion and the outer frame portion. Therefore, this configuration may not be used for the liquid crystal display device 10 that includes a frame with a small size.

As illustrated in FIG. 4, the frame 16 according to this embodiment includes high light reflective portions 29 and high light blocking portions 30. The high light reflective portions 29 each having a light reflectivity higher than that of the high light blocking portion 30 are opposite the respective LED non-opposing surfaces 19d. The high light blocking portions 30 each having a light blocking property higher than that of the high light reflective portions 29 are on the front side of the high light reflective portions 29 (the front side is away from the light exit surface 19b toward the opposite plate surface 19c of the light guide plate 19) in the Z-axis direction (the normal direction normal to the plate surface of the light guide plate 19). The frame 16 is formed using a dual-color molding technique and thus the high light reflective portions 29 and the high light blocking portions 30 are integrally formed as a single component. The high light reflective portion 29 and the high light blocking portion 30 each having a predetermined width and a thickness (a height) are placed on top of one another in the Z-axis direction. Namely, the frame 16 has a dual-layer configuration. With such a configuration, the high light reflective portions 29 of the frame 16 opposite the LED non-opposing surfaces 19d efficiently reflect rays of light that leak through the LED non-opposing edge surfaces 19d of the light guide plate 19 back to the LED non-opposing surfaces 19d. Therefore, light use efficiency improves. The high light reflective portions 29 have light reflectivity higher than that of the high light blocking portions 30 but have a light blocking property lower than that of the high light blocking portions 30. Therefore, rays of light may pass through the high light reflective portions 29. However, the high light blocking portions 30 that are on the front of the high light reflective portions 29 in the Z-axis direction appropriately block the rays of light that pass through the high light reflective portions 29. In particular, the high light blocking portions 30 in front of the high light reflective portions 29 properly block rays of light that exit through the LED non-opposing edge surfaces 19d and travel toward the front at angles to the normal direction. Thus, light is less likely to leak to the outside. Furthermore, the high light reflective portion 29 and the high light blocking portion 30 are arranged in the Z-axis direction. According to this configuration, the frame 16 that may have a small width is less likely to be subject to manufacturing constraints. Therefore, the frame 16 can be easily produced using the dual-color molding technique. That is, this configuration is preferable to reduce the frame size of the backlight device 12. Details of the high light reflective portion 29 and the high light blocking portion 30 will be described next.

As illustrated in FIGS. 2 and 4, each of the three bar portions (the two long-bar portions and one of the short-bar portions on the opposite side from the LED board supporting portion 16a) except the LED board supporting portion 16a includes the high light reflective portion 29 and the high light blocking portion 30. In other words, each of the three bar-portions that are along the respective LED non-opposing surfaces 19d of the light guide plate 19 includes the high light reflective portion 29 and the high light blocking portion 30. The high light reflective portion 29 is made of a white resin having a high light reflectivity (e.g., a resin material such as polycarbonate with a white coloring agent such as titanium oxide). A light reflectivity of the high light reflective portion 29 may be about 90%. As illustrated in FIGS. 2 to 4, the high light reflective portions 29 is arranged such that at least a portion of a surface thereof along the Z-axis direction is opposed to the LED board supporting portion 16a. Some of the high light reflective portions 29 are adjacent to the LED board supporting portion 16a (two of the high light reflective portions 29 included in the long-side bar portions of the frame 16) and in continuous with ends of the LED board supporting portion 16a in a long dimension thereof (the X-axis direction). The LED board supporting portion 16a is made of a material same as the one for the high light reflective portion 29 and formed at the same time as the high light reflective portion 29 using a single during molding of the frame 16. The high light reflective portion 29 has a height (a dimension in the Z-axis direction) which is substantially the same as a height of the LED board supporting portion 16a.

As illustrated in FIGS. 2 and 4, the high light reflective portions 29 of the three bar portions of the frame 16 are opposite the respective LED non-opposing surfaces 19d of the light guide plate 19. Each high light reflective portion 29 is arranged such that substantially an entire area of the surface thereof along the Z-axis direction is opposed to the LED non-opposing surface 19d. According to this configuration, the high light reflective portions 29 efficiently reflect back rays of light that leak through the LED non-opposing edge surfaces 19d to the LED non-opposing edge surfaces 19d. Further, the position of each high light reflective portion 29 in the Z-axis direction corresponds to the position of the LEDs 17 in the Z-axis direction. Among the rays of the light that is emitted by each LED 17, the large number of the rays of light travels in a normal direction normal to the light emitting surface 17a of the LED 17 (the Y-axis direction). Namely, the large number of rays of light that are inside the light guide plate 19 travels in a portion of the light guide plate 19 corresponding to the position of the light emitting surface 17a of the LED 17 in the Z-axis direction. With the high light reflective portion 29 that is arranged such that at least a position thereof along the Z-axis direction is opposed to the LEDs 17, the high light reflective portions 29 further efficiently reflects rays of light that leak through the LED non-opposing surfaces 19d back to the LED non-opposing surfaces 19d.

As illustrated in FIG. 4, the high light reflective portions 29 have a larger width than the high light blocking portions 30, which will be described later. That is, the high light reflective portions 29 constitute large-width portions 31. Each high light reflective portion 29 includes an outer surface 29a and an inner surface 29b. The outer surface 29a is opposite a corresponding inner surface of the peripheral wall 15b of the chassis 15 and arranged in contact or close to the inner surface of the peripheral wall 15b. The inner surface 29b is opposite the corresponding LED non-opposing surface 19d of the light guide plate 19 and flush with the LED non-arranged side surface 20a of the optical sheet 20. In this configuration, the inner surfaces 29b of the high light reflective portions 29 efficiently reflect back rays of light that leak through the LED non-opposing surfaces 19d to the LED non-opposing edge surfaces 19d. Namely, the rays of light reflected by the inner surfaces 29b are less likely to enter the LED non-arranged side surfaces 20a of the optical sheet 20. The frame 16 includes the large-width portions 31 that are constituted by the high light reflective portions 29. The inner surfaces 29b that are opposite the LED non-opposing surfaces 19d are located closer to the respective LED non-opposing surfaces 19d relative to small-width portions 32, which will be described later.

The high light blocking portions 30 are made of a black resin having a high light blocking property and a high light absorbing property (e.g. a resin material such as polycarbonate with a black coloring agent such as carbon black). Light transmissivity of the highlight blocking portions 30 at surfaces thereof may be about 0%. In comparison to the high light reflective portion 29, the high light blocking portion 30 has a relatively higher light blocking property and a higher light absorbing property but has a relatively lower light reflectivity and a relatively lower light transmissivity. According to this configuration, the high light blocking portion 30 absorbs rays of light that leaks from the light guide plate 19 through the LED non-opposing surface 19d and passes through the high light reflective portion 29. Thus, reflection is less likely to occur on the surface of the high light blocking portion 30. In comparison to the high light blocking portion 30, the high light reflective portion 29 has a relatively higher light reflectivity and light transmissivity but has a relatively lower light blocking property and a relatively small light absorbing property.

As illustrated in FIGS. 2 and 4, the high light blocking portions 30 of the bar portions of the frame 16 are arranged opposite the respective LED non-arranged side surfaces 20a of the optical sheet 20. Specifically, the high light blocking portions 30 are arranged opposite an entire area of the LED non-arranged side surfaces 20a in the Z-axis direction. In comparison to a configuration that high light reflective portions are arranged opposite the LED non-arranged side surfaces 20a of the optical sheet 20 in the Z-axis direction, rays of light coming from the high light blocking portions 30 are less likely to enter the optical sheet 20 through the LED non-arranged side surfaces 20a. That is, the optical sheet 20 is less likely to have bright spots in which the amount of light is larger than the other area in a plane of the optical sheet 20. According to this configuration, uneven brightness is less likely to occur in light that exits the backlight device 12. Each high light blocking portion 30 constitutes a front portion of the frame 16, namely, constitutes a portion of the frame 16 close to the liquid crystal panel 11. The high light blocking portion 30 supports the non-display area NAA of the liquid crystal panel 11 via the panel fixing member 26. Specifically, the high light blocking portions 30 support a large area of the outer portion of the liquid crystal panel 11 (the three edge portions expect the short-edge portion close to the LED printed circuit board 18) from the rear in the Z-axis direction (i.e., a side close to the light guide plate 19, or a side away from the light exit surface 19b toward the opposite plate surface 19c). More specifically, the high light blocking portions 30 of the three bar portions of the frame 16 except the LED board supporting portion 16a are opposite the liquid crystal panel 11 from the rear in the Z-axis direction. Front surfaces of the high light blocking portions 30 (a panel supporting surface) constitute an entire surface of the frame 16 to which the panel fixing member 26 is fixed. According to this configuration, the high light blocking portions 30 that support the liquid crystal panel 11 from the rear further appropriately support rays of light that leak from the light guide plate 19 through the LED non-opposing surfaces 19d and pass through the high light reflective portions 29. Thus, the rays of light through the high light reflective portions 29 are less likely to enter the non-display area NAA of the liquid crystal panel 11. The high light blocking portions 30 includes portions that overlap the peripheral walls 15b of the chassis 15 in the Z-axis direction. The front surfaces of the portions of the high light blocking portions 30 (the panel supporting surface) are located more to the front with respect to the peripheral walls 15b.

As illustrated in FIG. 4, each high light blocking portion 30 has a width smaller than the width of the high light reflective portion 29, that is, the high light blocking portion 30 constitutes the small-width portion 32. The high light blocking portion 30 includes an outer surface 30a and an inner surface 30b. The outer surface 30a is opposite the corresponding inner surface of the peripheral wall 15b of the chassis 15 and arranged close to or in contact with the inner surface of the peripheral wall 15b of the chassis 15. The inner surface 30b is opposite the corresponding LED non-arranged side surface 20a of the optical sheet 20 and located more to the outer side with respect to the inner surface 29b of the high light reflective portion 29. The outer surface 30a of the high light blocking portion 30 that is the small-width portion 32 is flush with the outer surface 29a of the high light reflective portion 29 that constitutes the large-width portion 31. The inner surface 30b of the high light blocking portion 30 is set back outward from the inner surface 29b of the high light reflective portion 29. The inner surface 30b and the LED non-arranged side surface 20a of the optical sheet 20 are spaced at a distance larger than the distance between the inner surface 29b of the high light reflective portion 29 and the LED non-opposing surface 19d of the light guide plate 19. That is, in comparison to the inner surface 30b of the high light blocking portion 30 that constitutes the small-width portion 32, the inner surface 29b of the high light reflective portion 29 that constitutes the large-width portion 31 is located closer to the LED non-opposing surface 19d of the light guide plate 19 and the LED non-arranged side surface 20a of the optical sheet 20. The high light reflective portions 29 include portions that protrude inward with respect to the respective high light blocking portions 30 so as to have a step-like form. The portions of the high light reflective portion 29 include the inner surfaces 30b, respectively. That is, the frame 16 has a cross section similar to a cross section of stairs. The high light blocking portion 30 constitutes an entirety of the small-width portion 32. The high light reflective portion 29 constitutes an entirety of the large-width portion 31. That is, the boundary between the large-width portion 31 and the small-width portion 32 corresponds to the boundary between the high light reflective portion 29 and the high light blocking portion 30. Thus, the structure of a die for a secondary molding used in the dual-color molding process of the frame 16 is simplified.

As illustrated in FIG. 4, the high light blocking portions 30 include peripheral-wall overlapping portions 33 that are placed on the front of the peripheral walls 15b of the chassis 15 in the Z-axis direction. Each peripheral-wall overlapping portion 33 protrudes outward from the outer surface 30a of the corresponding high light blocking portion 30. The peripheral-wall overlapping portions 33 are arranged such that the positions thereof in the normal directions normal to the respective LED non-opposing surfaces 19d of the light guide plate 19 (the X-axis direction or the Y-axis direction) correspond to the positions of the respective peripheral walls 15b of the chassis in the normal direction normal. The peripheral-wall overlapping portion 33 is a portion of the high light blocking portion 30 more to the front with respect to the peripheral wall 15b. With the peripheral-wall overlapping portions 33, the front portion of the high light blocking portion 30 has a larger width than a rear portion of the high light blocking portion 30. Thus, the high light blocking portion 30 further appropriately block light that passes through the high light reflective portion 29 and thus light is further less likely to leak to the outside.

As illustrated in FIGS. 3 and 4, the high light reflective portion 29 is arranged such that at least a portion of the surface thereof along the Z-axis direction is opposed to the LED board supporting portion 16a. The high light blocking portion 30 is arranged such that at least a portion of the surface thereof along the Z-axis direction is opposed to the LED printed circuit board 18. The high light blocking portion 30 is on the front of the high light reflective portion 29. The LED printed circuit board 18 is on the front of the LED board supporting portion 16a. As illustrated in FIG. 2, ends of a long dimension of the LED printed circuit board 18 (the dimension in the X-axis direction) do not overlap end portions of the high light blocking portions 30 close to the LED printed circuit board 18 (the high light blocking portions 30 include portions that are located at end portions of the two long-bar portions of the frame 16 close to the LED board supporting portion 16a) in a plan view. That is, gaps C are provided between the high light blocking portions 30 and the LED printed circuit board 18. Specifically, a portion of each high light blocking portion 30 constitutes the end portion of the long-bar portion of the frame 16 close to the LED board supporting portion 16a. The LED printed circuit board 18 is in between the portions of the high light blocking portions 30 with the gaps C therebetween. Each gap C opens frontward in the Z-axis direction and through which space in the backlight device 12 is communicated with an external space on the front side. Therefore, rays of light in the backlight device 12 may leak to the external space on the front side through the gaps C (e.g., rays of light that leak from the light guide plate 19 through the LED non-opposing surface 19d may be reflected by the high light reflective portion 29 but not returned to the LED non-opposing surface 19d or not absorbed by the high light blocking portion 30). The gaps C are between the LED printed circuit board 18 and the high light blocking portions 30 adjacent to the LED printed circuit board 18. That is, each gaps C is formed straight in the Y-axis direction, namely, in a direction in which the two long-bar portions or the high light blocking portions 30 that define the gaps C extend. In this configuration, a large amount of light may leak.

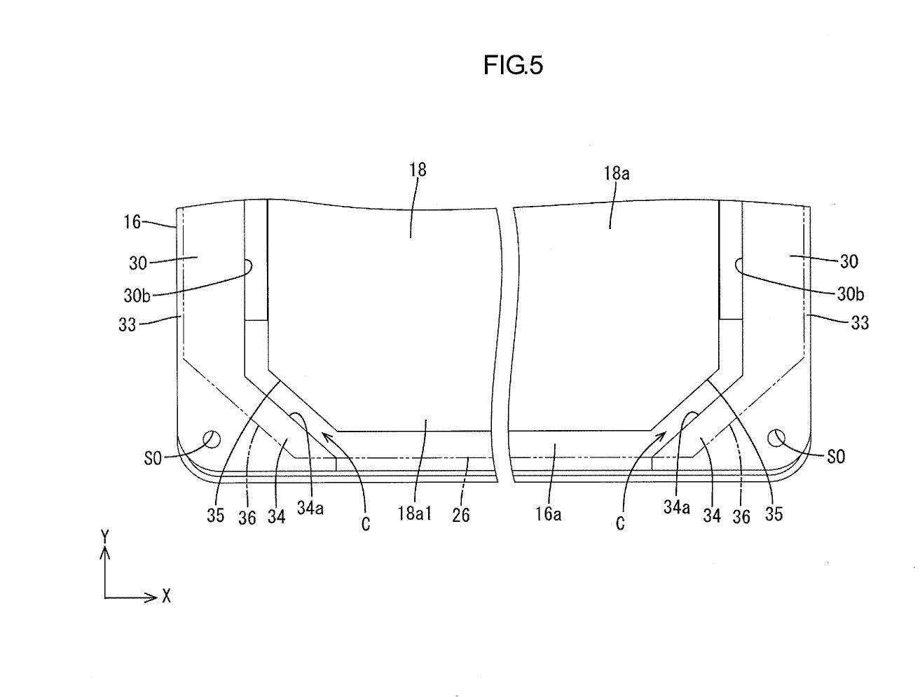

As illustrated in FIG. 5, the high light blocking portions 30 include the portions that are located at the ends of the two long-bar portions close to the LED board supporting portion 16a of the frame 16. The portions of the high light blocking portion 30 include extending portions 34 that extend inward (toward the LED board supporting portion 16a), respectively. In other words, the extending portions 34 are at the high light blocking portions 30 that extend along the LED non-opposing surfaces 19d that are adjacent to the LED opposing surface 19a of the light guide plate 19. The LED printed circuit board 18 includes cut portions 35 to receive the respective extending portions 34. Each extending portion 34, which is at the end portion of the high light blocking portion 30 close to the LED printed circuit board 18, extends inward from the inner surface 30. The extending portion 34 has a substantially triangular shape in a plan view. More specifically, the extending portion 34 has a right-angled isosceles triangular shape in a plan view. The extending portion 34 has an oblique portion 34a that is opposite the LED printed circuit board 18. The oblique portion 34a and the LED printed circuit board 18 define the gap C therebetween. The oblique portion 34a of the extending portion 34 forms an obtuse angle with the inner surface 30b of the high light blocking portion 30. The cut portions 35 are formed by cutting corners of the LED printed circuit board 18 on the opposite side from the light guide plate 19 such that the cut portions 35 are oblique to the X-axis direction and the Y-axis direction. That is, the cut portions 35 are at the ends of a long dimension of the LED printed circuit board 18. Each cut portion 35 is substantially parallel to the corresponding extending portion 34 and thus the gap C between the cut portion 35 and the extending portion 34 is a constant gap. The gap C extends in a direction oblique to the X-axis direction and the Y-axis direction. Specifically, the gap C between the cut portion 35 and the extending portion 34 extends at an angle of about 45° with respect to the X-axis direction and the Y-axis direction. In this configuration, a region of each gap C defined by portions of the LED printed circuit board 18 and the highlight blocking portion 30 other than the extending portion 34 and the cut portion 35 extends straight in the Y-axis direction in a plan view. On the other hand, a region of each gap C defined by the extending portion 34 and the cut portion 35 extends oblique to the X-axis direction and the Y-axis direction in a plan view. That is, the overall gap C does not extends straight. According to this configuration, even if light leaks through the gap C, the amount of light that leaks therethrough reduces. In FIG. 5, the panel fixing member 26 is illustrated with a two dot chain line. The panel fixing member 26 includes chamfered corners parallel to the oblique portions 34a of the respective extending portions 34 (and the respective cut portions 35). The chamfered corners may be formed by cutting corners of the panel fixing member 26 that may overlap the extending portions 34 such that they are angled with respect to the X-axis direction and the Y-axis direction. The chamfered corners are referred to as fixing member cut portions 36. The frame 16 includes screw holes SO at four corners thereof for other components to be fixed to the frame 16.

This embodiment has the configuration described above. Functions of this embodiment will be described. When the liquid crystal display device 10 is turned on, signals related to images are transmitted from the panel driving circuit board to the liquid crystal panel 11 via the flexible printed circuit board 14 and the driver 13 and thus the LEDs 17 are lit. As illustrated in FIG. 3, the light guide plate 19 guides rays of light from the LEDs 17 to the optical sheet 20 and thus the rays of light pass through the optical sheet 20. As a result, the light from the LEDs 17 is converted into even planar light. The liquid crystal panel 11 is illuminated with the planar light and thus predetermined images are displayed in the display area AA of the liquid crystal panel 11.

Functions of the backlight device 12 will be described in detail. As illustrated in FIG. 3, when the LEDs 17 are turned on, rays of light exit the LEDs 17 and enter the light guide plate 19 through the LED opposing surface 19a. The rays of light in the light guide plate 19 are totally reflected by an interface between the light guide plate 19 and an air space outside of the light guide plate 19, or reflected by the reflection sheet 21. Then, the rays of light travel throughout the light guide plate 19 and exit through the light exit surface 19b toward the optical sheet 20. However, not all of rays of light that travel through the light guide plate 19 exit the light guide plate 19. Some of the rays of light leak the light guide plate 19 through the LED non-opposing surfaces 19d. As illustrated in FIG. 4, the frame 16 that surrounds the light guide plate 19 includes the high light reflective portions 29 that are opposite the LED non-opposing surfaces 19d. Thus, the high light reflective portions 29 efficiently reflect back the rays of light that leak through the LED non-opposing surfaces 19d to the LED non-opposing surfaces 19d. That is, the light use efficiency improves. Furthermore, the high light reflective portions 29 are arranged such that the inner surfaces 29b thereof are flush with the respective LED non-arranged surfaces 20a of the optical sheet 20. According to this configuration, light from the light guide plate 19 through the LED non-opposing surfaces 19d tend to stay in space provided between the LED non-opposing surfaces 19d of the light guide plate 19 and the inner surfaces 29b of the high light reflective portions 29. Thus, rays of light that leak from the light guide plate 19 are less likely to enter the LED non-arranged surfaces 20a of the optical sheet 20. Namely, uneven brightness is less likely to occur in the light that exits from the backlight device 12. Furthermore, the high light reflective portions 29 are arranged such that portions thereof along the Z-axis direction are opposed to the light guide plate 19 and the position of the LEDs 17. According to this configuration, the high light reflective portions 29 efficiently reflect back rays of light that leak out through the LED non-opposing surfaces 19d to the LED non-opposing edge surfaces 19d. Therefore, the light use efficiency further improves.

The high light reflective portion 29 has a higher light reflectivity but has a relatively lower light blocking property. Therefore, a certain amount of light passes through the high light reflective portion 29. In this embodiment, as illustrated in FIG. 4, the high light blocking portion 30 is on the front of the high light reflective portion 29 in the Z-axis direction. Thus, the high light blocking portion 30 blocks the rays of light that passes through the high light reflective portion 29, so that light is less likely to leak to the outside of the backlight device 12. In particular, the high light blocking portions 30 that are on the front of the high light reflective portions 29 efficiently block the rays of light that travel in directions oblique to the front through the LED non-opposing surface 19d. Thus, light is further less likely to leak to the outside of the backlight device 12. The high light blocking portions 30 constitute an entire area of a supporting portion of the frame 16 for supporting the non-display area NAA of the liquid crystal panel 11. Therefore, light that passes the high light reflective portion 29 is less likely to directly enter the non-display area NAA of the liquid crystal panel 11. The high light blocking portion 30 is arranged such that at least a portion thereof along the Z-axis direction is opposed to the optical sheet 20. Thus, light that passes through the high light reflective portion 29 is less likely to enter the optical sheet 20 through the LED non-arranged surface 20a. As illustrated in FIG. 5, the region of the gap C defined by the portions of the LED printed circuit board 18 and the high light blocking portion 30 other than the extending portion 34 and the cut portion 35 extends straight in the Y-axis direction in a plan view, but the region of the gap C defined by the extending portion 34 and the cut portion 35 extends oblique to the X-axis direction and the Y-axis direction in a plan view. That is, the gap C does not extend in a straight line. With this configuration, even if light leaks to the front outward through the gap C between the LED printed circuit board 18 and the high light blocking portion 30, the amount of light that leaks through the gap C reduces. Thus, the quality of images displayed in the display area AA of the liquid crystal panel 11 improves. Furthermore, the light use efficiency of the backlight device 12 increases. Namely, this configuration is effective for increasing brightness and reducing power consumption.

As described above, the backlight device (a lighting device) 12 according to this embodiment includes the LEDs (a light source) 17, the light guide plate 19, and the frame 16. The light guide plate 19 includes the peripheral surfaces and the plate surfaces. One of the peripheral surfaces is the LED opposing surface 19a (a light source opposing surface) which faces the LEDs 17 and through which light from the LEDs 17 enters the light guide plate 19. The other peripheral surfaces are the LED non-opposing surfaces 19d (a light source non-opposing surface) which are not opposite the LEDs 17. One of the plate surfaces is the light exit surface 19b through which light exits the light guide plate 19. The other plate surface is the opposite plate surface 19c on the opposite side from the light exit surface 19b. The frame 16 has a frame-like shape that surrounds the light guide plate 19. The frame 16 includes the high light reflective portions 29 and the high light blocking portions 30. The high light reflective portions 29 are opposite at least the LED non-opposing surfaces 19d of the light guide plate 19. The high light blocking portions 30 are arranged at ends of the high light reflective portions 29 in the direction parallel to the direction from the light exit surface 19b to the opposite plate surface 19c along the normal direction normal to the plate surfaces of the light guide plate 19. The high light blocking portions 30 have light reflectivity lower than that of the high light reflective portions 29. The high light blocking portions 30 have light blocking properties higher than the high light reflective portions 29.

According to this configuration, light from the LEDs 17 enters the light guide plate 19 through the LED opposing surface 19a, travels inside the light guide plate 19, and exits the light guide plate 19 through the light exit surface 19b. Light that travels inside the light guide plate 19 may leak out through the LED non-opposing surfaces 19d, which are the peripheral surfaces not opposite the LEDs 17. Even in such a case, the light that leaks from the light guide plate 19 is efficiently reflected back to the LED non-opposing edge surfaces 19d by the high light reflective portions 29 of the frame 16 that surrounds the light guide plate 19. The high light reflective portions 29 that are opposite at least the LED non-opposing surfaces 19d of the light guide plate 19 have a light reflectivity higher than that of the high light blocking portions 30. Thus, light use efficiency improves.

The high light reflective portions 29 have a light reflectivity higher than that of the high light blocking portions 30 but have a light blocking property lower than that of the high light blocking portions 30. Therefore, light is more likely to pass through the high light reflective portions 29 and the light therethrough may leak to the outside of the high light reflective portions 29. However, the high light blocking portions 30 that are on the side of the high light reflective portions 29 closer to the light exit surface 19b than the opposite plate surface 19c in the normal direction normal to the plate surfaces of the light guide plate 19 have a light blocking property higher than that of the high light reflective portions 29. Therefore, the high light blocking portions 30 appropriately block the light that passes through the high light reflective portions 29. Specifically, the high light blocking portions 30 are arranged farther from the opposite plate surface 19c than the high light reflective portions 29 is in the normal direction normal to the plate surfaces of the light guide plate 19. Thus, the high light blocking portion 30 properly block rays of light that leaks through the LED non-opposing surfaces 19d, travels in the oblique directions that are oblique to the normal direction normal to the LED non-opposing surface 19d, and passes through the high light reflective portion 29. Namely, leakage of light to the outside is preferably suppressed. Furthermore, the high light reflective portion 29 and the high light blocking portion 30 are arranged in the normal direction normal to the plate surface of the light guide plate 19. According to this configuration, the frame 16 that has a small width is less likely to be subject to manufacturing constrains. Therefore, the frame 16 can be easily produced using the dual-color molding technique. That is, this configuration is preferable to reduce the frame size of the backlight device 12.

The backlight device 12 includes the optical sheet 20 having the plate surfaces that extends along the plate surfaces of the light guide plate 19 and faces the light exit surface 19b of the light guide plate 19. The high light blocking portions 30 have a light absorbing property higher than the high light reflective portions 29. The high light blocking portion 30 is arranged such that at least a portion thereof along the normal direction normal to the plate surfaces of the light guide plate 19 is opposed to the LED non-arranged side surfaces 20a of the optical sheet 20 (an end surface). According to this configuration, the highlight blocking portions 30 having a light absorbing property higher than that of the high light reflective portion 29 preferably absorb light that passes through the high light reflective portions 29. Namely, light is less likely to be reflected by the surfaces of the high light blocking portions 30. Furthermore, the high light blocking portions 30 are arranged such that portions thereof along the normal direction normal to the plate surfaces of the light guide plate 19 are opposed to the respective high light blocking portions 30. According to this configuration, light reflected by the high light blocking portions 30 is less likely to enter the optical sheet 20 through the LED non-arranged side surface 20a of the optical sheet 20. Thus, uneven brightness is less likely to occur in light that exits the backlight device 12.

The high light reflective portions 29 include opposite surfaces that are opposed the respective LED non-opposing surfaces 19d of the light guide plate 19. The opposite surfaces and the respective LED non-arranged side surfaces 20a of the optical sheet 20 are flush with each other. According to this configuration, when light that leaks from the light guide plate 19 through the LED non-opposing surfaces 19d is reflected by the high light reflective portions 29, light that is reflected by the high light reflective portions 29 is efficiently returned to the LED non-opposing surfaces 19d. Thus, the light that is reflected is less likely to enter the optical sheet 20 through the LED non-arranged side surfaces 20a. Namely, light use efficiency is further improved and uneven brightness is further less likely to occur in light that exits the backlight device 12.

The backlight device 12 includes the chassis 15 that holds the LEDs 17, the light guide plate 19, and the frame 16 therein. The chassis 15 includes the bottom plate 15a and the peripheral walls 15b. The bottom plate 15a extends along the plate surfaces of the light guide plate 19. The peripheral walls 15b that extend upward from the edges of the bottom plate 15a and surround the frame 16. The high light blocking portions 30 include the peripheral-wall overlapping portions 33 that are disposed on ends of the respective peripheral walls 15b in the direction parallel to the direction from the opposite plate surface to the light exit surface along the normal direction normal to the plate surfaces of the light guide plate 19. According to this configuration, the width of the high light blocking portion 29 increases by the size of the peripheral-wall portion 33. Thus, light that passes through the high light reflective portions 29 are more properly blocked and light leakage is more preferably suppressed.

The highlight reflective portion 29 is arranged such that at least a portion of a surface thereof along the normal direction normal to the plate surface of the light guide plate 19 is opposed to the LEDs 17. A large amount of light inside the light guide plate 19 tends to travel through a portion of the light guide plate 19 located corresponding to the LEDs 17 in the normal direction normal to the plate surface of the light guide plate 19. With the high light reflective portions 29 that are arranged corresponding to the LEDs 17 in the normal direction normal to the plate surface of the light guide plate 19, light that leaks from the light guide plate 19 through the LED non-opposing surfaces 19d is efficiently reflected back to the LED non-opposing e surfaces 19d. Therefore, the light use efficiency further increases.

The high light reflective portion 29 are arranged such that the entire areas of surfaces thereof in the normal direction normal to the plate surface of the light guide plate 19 are opposed to the LED non-opposing surfaces 19d. According to this configuration, namely, the configuration that the entire areas of the high light reflective portions 29 in the normal direction normal to the plate surface of the light guide plate 19 corresponds to the LED non-opposing surfaces 19d, light that leaks from the light guide plate 19 through the LED non-opposing surfaces 19d is efficiently reflected back to the LED non-opposing surfaces 19d by the high light reflective portions 29. Thus, light use efficiency further improves.

The high light reflective portion 29 and the high light blocking portion 30 of the frame 16 are integrally formed by dual-color molding. According to this configuration, since the high light reflective portion 29 and the high light blocking portion 30 are arranged in the normal direction normal to the plate surface of the light guide plate 19, the frame 16 can be easily prepared using the dual-color molding technique even if the frame is restricted to have a small width. Therefore, this configuration is preferable to reduce the size of the frame 16.

The frame 16 includes the large-width portions 31 having a relatively large width and the small-width portions 32 having a relatively small width. The small-width portions 32 are on ends of the large-width portions 31 in the direction parallel to the direction from the opposite plate surface 19c to the light exit surface 19b along the normal direction normal to the plate surface of the light guide plate 19. The large-width portions 31 constitute the high light reflective portions 29 and the small-width portions 32 constitute the high light blocking portions 30. According to this configuration, the position of the boundary between the large-width portion 31 and the small-width portion 32 matches the position of the boundary between the high light reflective portion 29 and the high light blocking portion 30. Thus, a die for a secondary molding used during the dual-color molding process can have a simple structure.

The large-width portions 31 are closer to the respective LED non-opposing surfaces 19d of the light guide plate 19 relative to the small-width portions 32. According to this configuration, light that leaks from the light guide plate 19 through the LED non-opposing surfaces 19d is further efficiently reflected by the high light reflective portions 29, that is, by the large-width portions 31.

The backlight device 12 includes the LED printed circuit board 18 (a light source board) on which the LEDs 17 are mounted. The LED printed circuit board 18 is arranged such that at least a portion of a surface thereof along the normal direction normal to the plate surfaces of the light guide plate 19 is opposed to the high light reflective portion 29 with space between the high light reflective portion 29 and the high light blocking portion 30. The frame 16 includes the LED board supporting portion (a light source board supporting portion) 16a for supporting at least a portion of an end of the LED board supporting portion 16a in the direction parallel to the direction from the light exit surface 19b to the plate surface of the light guide plate 19 along the normal direction normal to the plate surfaces of the light guide plate 19. The LED board supporting portion 16a is along the LED opposing surface 19a. The high light blocking portion 30 of the frame 16 adjacent to the LED opposing surface 19a of the light guide plate 19 includes the extending portion 34 that extend toward the LED board supporting portion 16a. The LED printed circuit board 18 includes the cut portions 35 to receive the extending portions 34. The LED printed circuit board 18 is arranged such that a portion thereof along the normal direction normal to the plate surface of the light guide plate 19 is opposed to the high light blocking portions 30. The gaps C are in between the LED printed circuit board 18 and the portions of the high light blocking portions 30. Therefore, light may leak out through the gaps C. However, the bar portions along the LED non-opposing surfaces 19d, which are adjacent to the LED opposing surface 19a of the light guide plate 19, include the high light blocking portions 30 that include the extending portions 34. The extending portions 34 extend toward LED board supporting portion 16a that supports the LED printed circuit board 18. Furthermore, the LED printed circuit board 18 includes the cut portions 35 that receive the corresponding extending portions 34. In this configuration, the gaps C between the LED printed circuit board 18 and the high light blocking portions 30 are less likely to extend straight in a view in the normal direction normal to the plate surface of the light guide plate 19. Therefore, even if light leaks through the gaps C, the amount of the light that leaks therethrough reduces.

The extending portion 34 and the cut portion 35 are formed such that edges thereof adjacent to each other are oblique when viewed in the normal direction normal to the plate surfaces of the light guide plate 19. According to this configuration, the LED printed circuit board 18 does not include right angled corners at positions corresponding to the cut portions 35. Thus, stress is less likely to concentrate at a portion of the LED printed circuit board 18 and thus breakage of the LED printed circuit board 18 is less likely to occur.

The liquid crystal display device (a display device) 10 according to this embodiment includes the backlight device 12 and the liquid crystal panel (a display device) 11 configured to display an image using light from the backlight device 12. According to the liquid crystal display device 10, since the liquid crystal display device 10 includes the backlight device 12 that suppresses light leakage with the frame having a small size, the displaying performance of the liquid crystal display device 10 is improved with the frame having a small size.

The frame 16 is arranged such that the high light blocking portions 30 thereof support the liquid crystal panel 11 from a surface of the liquid crystal panel 11 close to the light guide plate 19. According to this configuration, when light leaks from the light guide plate 19 through the LED non-opposing surfaces 19d and passes through the high light reflective portions 29, the light that passes through the high light reflective portions 29 is blocked by the high light blocking portions 30. That is, the light that passes through the high light reflective portions 29 is less likely to enter the liquid crystal panel 11. Thus, the quality of images displayed on the liquid crystal panel 11 improves.

The display panel is the liquid crystal panel 11 including the liquid crystals. The display device can be used as the liquid crystal display device 10 for many applications such as displays of portable information terminals such as smart phones and tablet-type personal computers.

### Second Embodiment

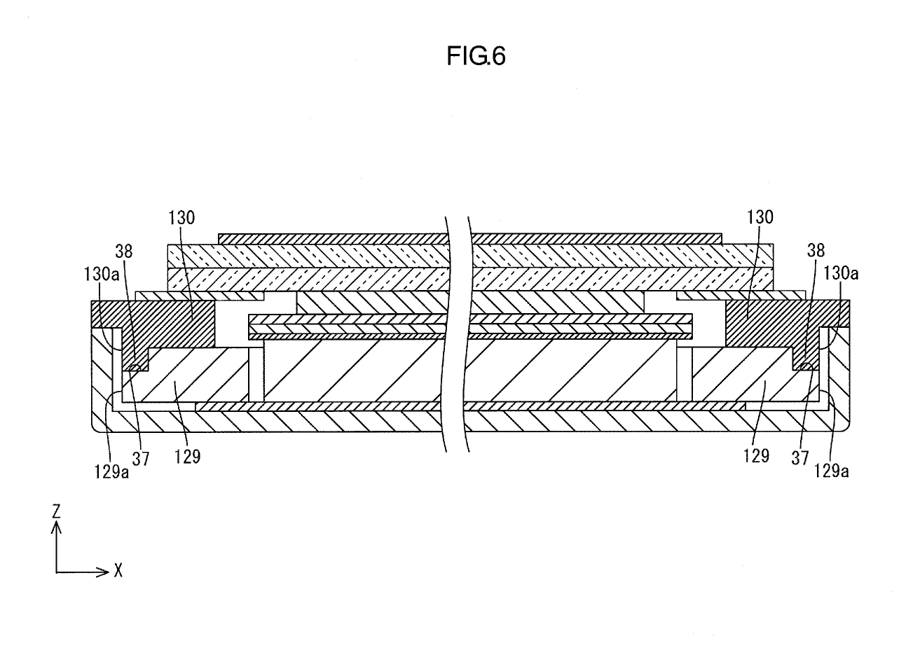

A second embodiment will be described with reference to FIG. 6. High light reflective portions 129 and high light blocking portions 130 of the second embodiment have different cross sections from those in the first embodiment. Other configurations are similar to the first embodiment and thus configurations, functions, and effects of those will not be described.

As illustrated in FIG. 6, each high light reflective portion 129 has a recess 37 that is formed at an interface between the high light reflective portion 129 and the high light blocking portion 130. Each high light blocking portion 130 has a protrusion 38 at the interface between the high light reflective portion 129 and the high light blocking portion 130. The recess 37 and the protrusion 38 are fitted to each other. The recess 37 and the protrusion 38 formed at the interface are located at an outer edge of the high light reflective portion 129 and an outer edge of the high light blocking portion 130, respectively. That is, an outer surface 129a of the high light reflective portion 129 has a small size due to the recess 37, and an outer surface 130a of the high light blocking portion 130 has a large size due to the protrusion 38. With the recesses 37 and the protrusions 38, total surface areas of the high light reflective portions 129 and the high light blocking portions 130 located therebetween increases. Namely, this configuration increases adhesion between the high light reflective portions 129 and the high light blocking portions 130 that are integrally formed by dual-color molding. The recesses 37 and the protrusions 38 extend in directions in which the high light reflective portions 129 and the high light blocking portions 130 extend (a direction perpendicular to the width direction).

### Third Embodiment

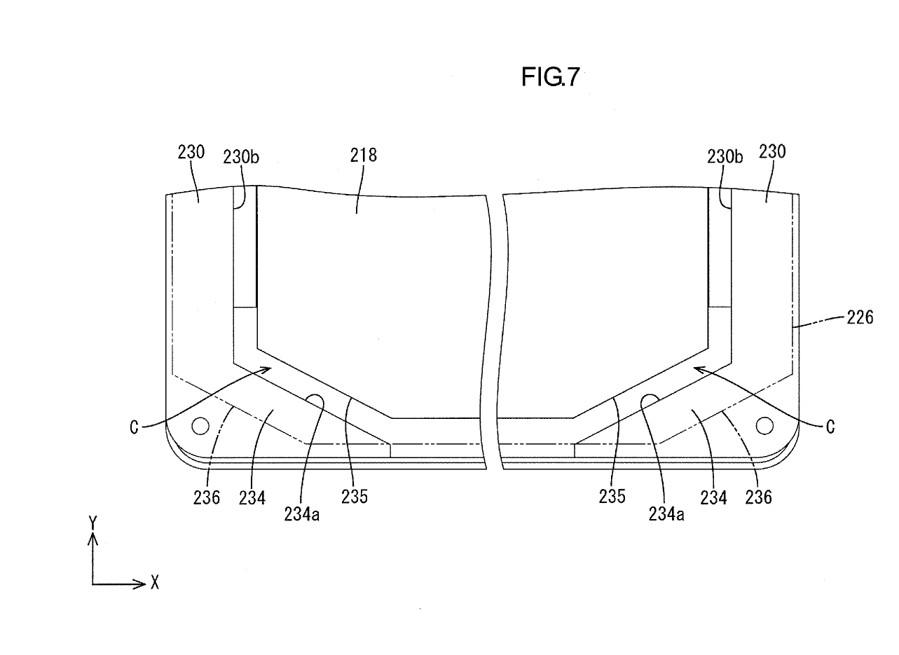

A third embodiment will be described with reference to FIG. 7. The planer shapes of extending portions 234 and cut portions 235 in the third embodiment are modified from those in the first embodiment. Other configurations are similar to the first embodiment and thus configurations, functions, and effects of those will not be described.

As illustrated in FIG. 7, each extending portion 234 has a right-angled triangular shape having two sides adjacent to an oblique portion 234a, and the lengths of the two sides are different from each other. The oblique portion 234a of the extending portion 234 forms an obtuse angle with an inner surface 230b of the corresponding high light blocking portion 230. The obtuse angle of this embodiment is smaller than that of the first embodiment. In other words, the angle between the oblique portions 234a and the inner surface 230b is closer to the right angle. The cut portions 235 of an LED printed circuit board 218 are substantially parallel to the respective oblique portions 234a. In this configuration, regions of gaps C defined by the extending portions 234 and the cut portions 235 extend at an angle from regions of the gaps C defined by portions of the LED printed circuit boards 218 and the high light blocking portions 230 other than the extending portions 234 and the cut portions 235. Thus, the amount of light that leaks through the gaps C reduces. A panel fixing member 226 includes fixing member cut portions 236 that are substantially parallel to the respective oblique portions 234a of the extending portions 234 and cut portions 235 of the LED printed circuit boards 218.

### Fourth Embodiment

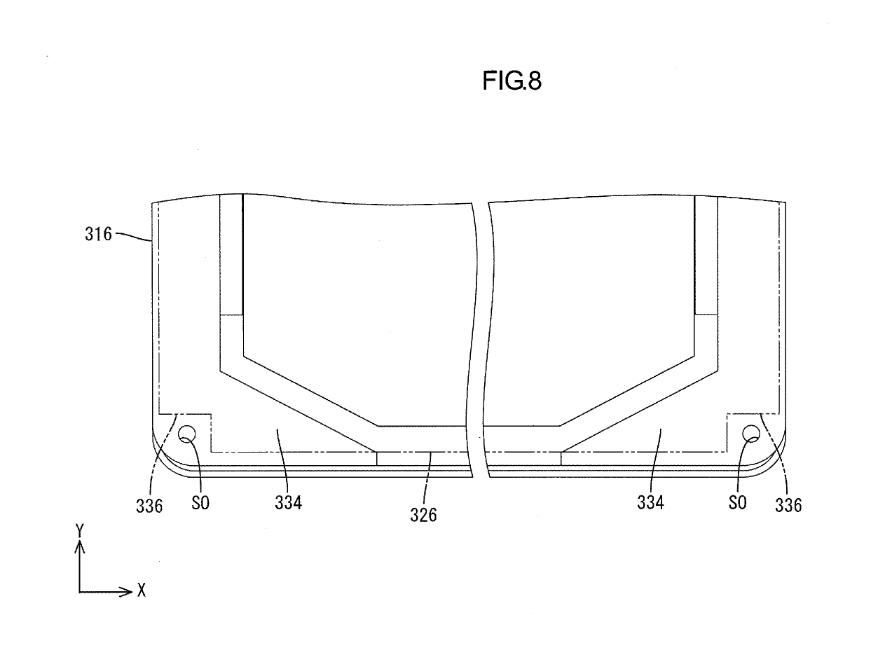

A fourth embodiment will be described with reference to FIG. 8. The planar shape of fixing member cut portions 336 of the fourth embodiment is modified from the one in the third embodiment. Other configurations are similar to the third embodiment and thus configurations, functions, and effects of those will not be described.

As illustrated in FIG. 8, each fixing member cut portion 336 of a panel fixing member 326 has a rectangular notched shape in a plan view. The fixing member cut portions 336 are formed at positions corresponding to the screw holes SO that are formed in four corners of a frame 316. According to this configuration, screws to be fitted in the respective screw holes SO are less likely to contact the panel fixing member 326. The fixing member cut portions 336 are formed smaller in dimension than those in the third embodiment and thus the panel fixing member 326 has a larger area. Thus, adhesiveness of the panel fixing member 326 to the frame 16 (in particular, to the extending portion 334) increases.

### Fifth Embodiment

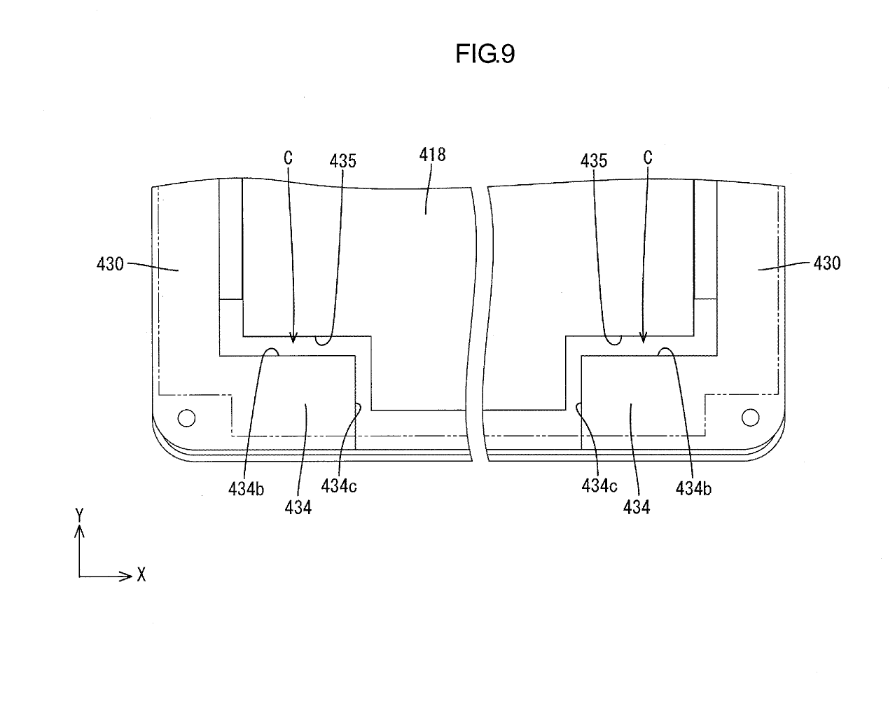

A fifth embodiment will be described with reference to FIG. 9. In the fifth embodiment, the planer shapes of extending portions 434 and cut portions 435 are modified from those in the fourth embodiment. Other configurations are similar to the fourth embodiment and thus configurations, functions, and effects of those will not be described.

As illustrated in FIG. 9, the extending portions 434 and the cut portions 435 have rectangular shapes in a plan view. Each extending portion 434 includes an inner surface 434b and an inner surface 434c that define a portion of a gap C. The inner surfaces 434b are referred to as first inner surfaces 434b that are substantially right-angled with respect to inner surfaces 430b of high light blocking portions 430. The inner surfaces 434c are referred to as second rear surfaces 434c that are substantially right-angled with respect to the respective first inner surfaces 434b. The cut portions 435 each extend along the inner surfaces 434b and 434c such that the gap C defined by the cut portion 435 and the extending portion 434 is constant in a plan view. That is, each gap C defined by an LED printed circuit board 418 and the high light blocking portion 430 is in a cranked shape having two bent portions in a plan view. According to this configuration, light is less likely to leak through the gaps C.

### Sixth Embodiment

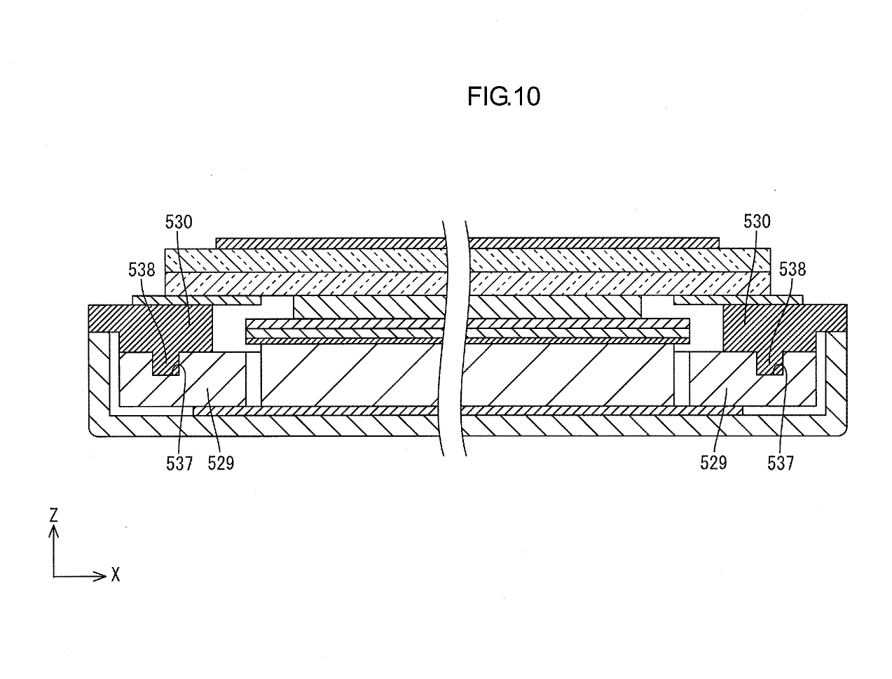

A sixth embodiment will be described with reference to FIG. 10. The cross sections of high light reflective portions 529 and high light blocking portions 530 of the sixth embodiment are modified from those in the second embodiment. Other configurations are similar to the second embodiment and thus configurations, functions, and effects of those will not be described.

As illustrated in FIG. 10, a recess 537 of each high light reflective portion 529 formed at an interface between the high light reflective portion 529 and the high light blocking portion 530 is located at a middle portion of the high light reflective portion 529. A protrusion 538 of each high light blocking portion 530 formed at the interface between the high light reflective portion 529 and the high light blocking portion 530 is located at a middle portion of the high light blocking portion 530. According to this configuration, total surface areas of the high light reflective portions 529 and surfaces of the high light blocking portions 530 located therebetween further increase. Namely, this configuration further increases adhesion between the high light reflective portions 529 and the high light blocking portions 530 that are integrally formed by dual-color molding.

### Seventh Embodiment

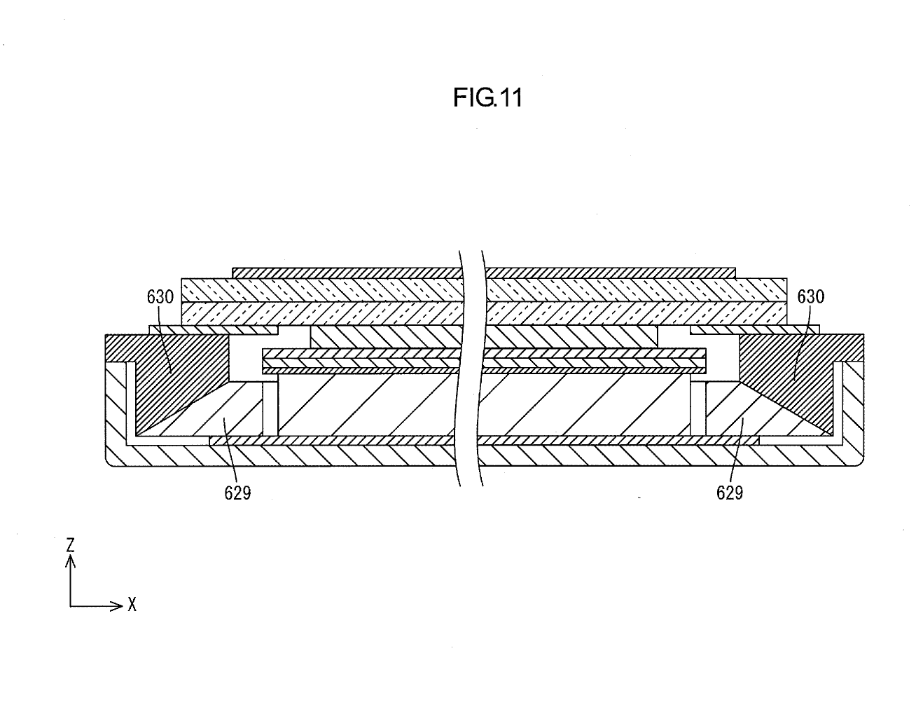

A seventh embodiment will be described with reference to FIG. 11. The cross sections of high light reflective portions 629 and high light blocking portions 630 of the seventh embodiment are modified from those in the first embodiment. Other configurations are similar to the first embodiment and thus configurations, functions, and effects of those will not be described.

As illustrated in FIG. 11, the high light reflective portion 629 and the high light blocking portion 630 each have a height that gradually varies in the width directions thereof. Specifically, the height of the highlight reflective portion 629 gradually increases in the width direction from an outer end toward an inner end thereof. The height of the high light blocking portion 630 gradually decreases in the width direction from an outer end toward an inner end thereof. That is, an interface between the high light reflective portion 629 and the high light blocking portion 630 is sloped relative to the Z-axis direction in a cross-sectional view.

### Eighth Embodiment

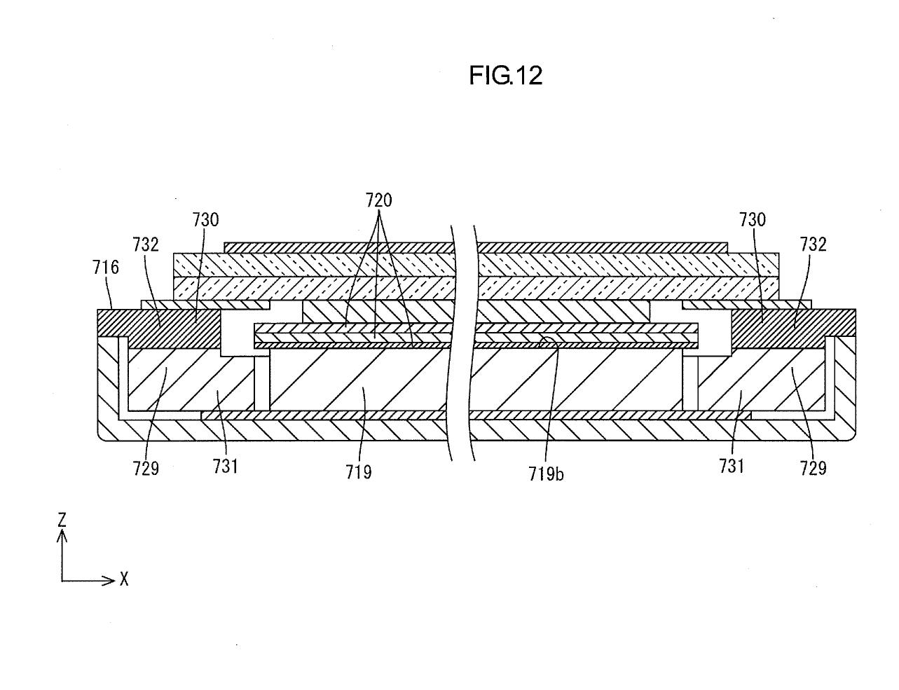

An eighth embodiment will be described with reference to FIG. 12. In the eighth embodiment, the position of the boundary between high light reflective portions 729 and high light blocking portions 730 are modified from the one in the first embodiment. Other configurations are similar to the first embodiment and thus configurations, functions, and effects of those will not be described.

As illustrated in FIG. 12, the position of the boundary between the high light reflective portions 729 and the high light blocking portions 730 corresponds to the position of the boundary between a light guide plate 719 and an optical sheet 720 (the position of a light exit surface 719b in the height direction). That is, an entirety of a large-width portion 731 of a frame 716 is made of the high light reflective portion 729, whereas a small-width portion 729 is made of the high light blocking portion 730 and the high light reflective portion 729. Even in this configuration, an entire area of the surface of the high light reflective portion 729 along the Z-axis direction is opposed to the light guide plate 719 while an entire area of the surface of the high light blocking portion 730 along the Z-axis direction is opposed to the optical sheet 720.

### Ninth Embodiment

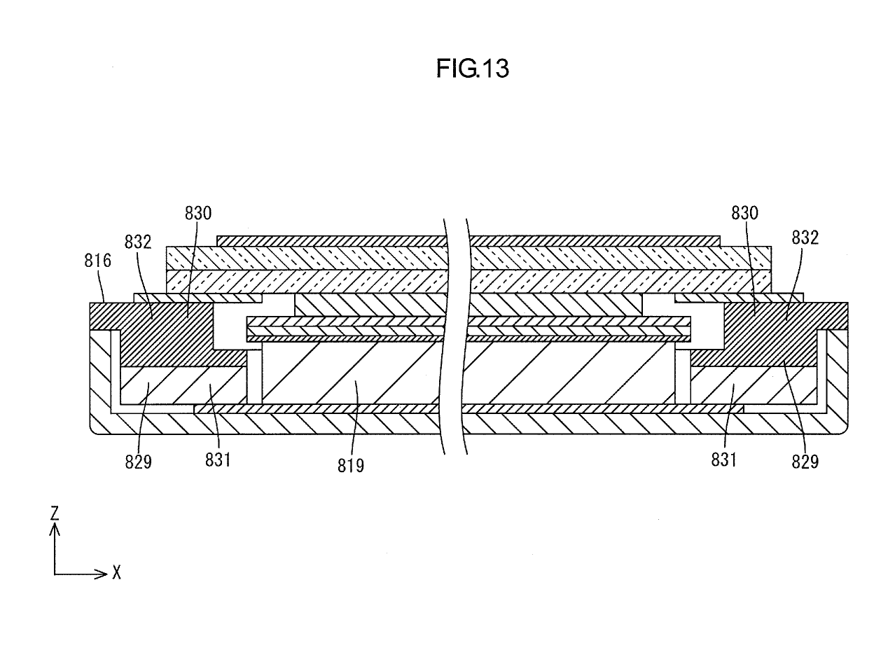

A ninth embodiment will be described with reference to FIG. 13. In the ninth embodiment, the position of a boundary between high light reflective portions 829 and high light blocking portions 830 is modified from the one in the eighth embodiment. Other configurations are similar to the eighth embodiment and thus configurations, functions, and effects of those will not be described.

As illustrated in FIG. 13, the position of the boundary between the high light reflective portions 829 and the high light blocking portions 830 in the Z-axis direction overlaps the position of a light guide plate 819 in the Z-axis direction. That is, an entirety of a small-width portion 832 of a frame 816 is made of the high light blocking portion 830 while a large-width portion 831 is made of the high light reflective portion 829 and a portion of the high light blocking portion 830.

### Tenth Embodiment

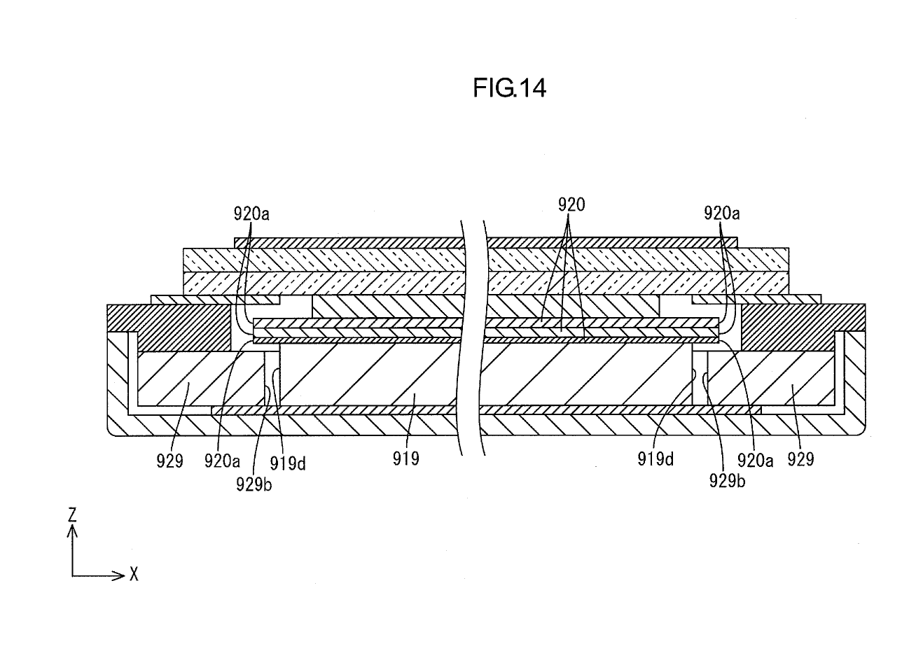

A tenth embodiment will be described with reference to FIG. 14. In the tenth embodiment, the position of inner surfaces 929b of high light reflective portions 929 with respect to LED non-arranged side surfaces 920a of an optical sheet 920 is modified from the one in the first embodiment. Other configurations are similar to the first embodiment and thus configurations, functions, and effects of those will not be described.

As illustrated in FIG. 14, the inner surface 929b of each high light reflective portion 929 according to this embodiment is closer to a corresponding LED non-opposing surface 919d of a light guide plate 919 than the LED non-arranged side surface 920a of the optical sheet 920 is. According to this configuration, the inner surfaces 929b of the high light reflective portions 929 reflect rays of light that leaks from a light guide plate 919 through the LED non-opposing surfaces 919d. Thus, the rays of light reflected thereby are less likely to enter the LED non-arranged side surfaces 920a of the optical sheet 920.

As described above, the high light reflective portions 929 of this embodiment are arranged such that the surfaces thereof opposed to the LED non-opposing surfaces 919d of the respective light guide plate 919 are located closer to the LED non-opposing surfaces 919d than the LED non-arranged side surfaces 920a of the optical sheet 920 are. According to this configuration, the high light reflective portions 929 appropriately reflect rays of light that leaks through the LED non-opposing surfaces 919d of the light guide plate 919 back to the LED non-opposing surfaces 919d. Namely, rays of light are less likely to enter the LED non-arranged side surfaces 920a of the optical sheet 920. Thus, light use efficiency further improves and uneven brightness is less likely to occur in light that exits the backlight device.

### Eleventh Embodiment

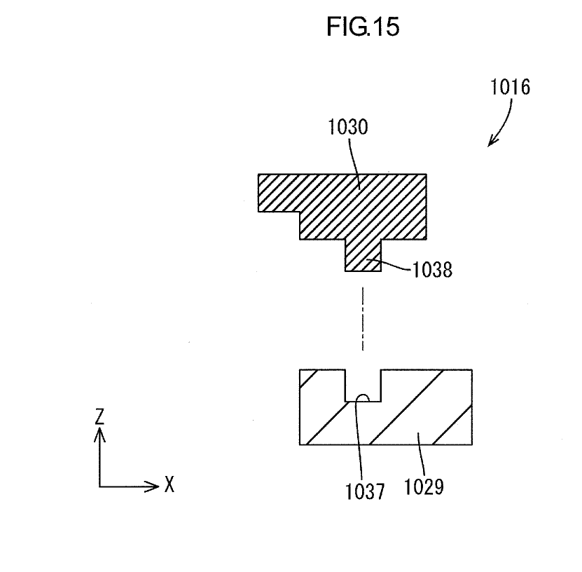

An eleventh embodiment will be described with reference to FIG. 15. High light reflective portions 1029 and high light blocking portions 1030 of the eleventh embodiment have the same cross sections as those in the sixth embodiment but the high light reflective portions 1029 and the high light blocking portions 1030 are separate components. Other configurations are similar to the sixth embodiment and thus configurations, functions, and effects of those will not be described.

As illustrated in FIG. 15, a frame 1016 according to this embodiment is made with two components, namely, the high light reflective portion 1029 and the high light blocking portion 1030 that are connected to each other. The high light reflective portion 1029 and the high light blocking portion 1030 are separately molded with resin using different dies. After molding, a recess 1037 of the high light reflective portion 1029 and a protrusion of the high light blocking portion 1030 are fitted to connect the high light reflective portion 1029 and the high light blocking portion 1030.

### Twelfth Embodiment

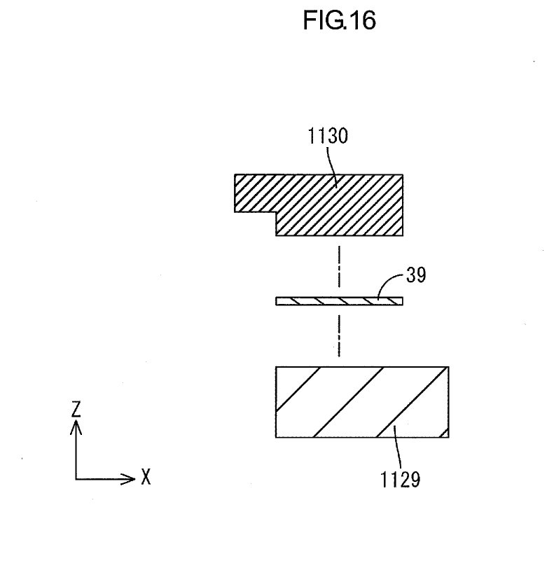

A twelfth embodiment will be described with reference to FIG. 16. Configurations of the twelfth embodiment in which high light reflective portions 1129 and high light blocking portions 1130 are fixed are different from those in the eleventh embodiment. Other configurations are similar to the eleventh embodiment and thus configurations, functions, and effects of those will not be described.

As illustrated in FIG. 16, surfaces of the high light reflective portion 1129 and the high light blocking portion 1130 therebetween are flat, respectively. The high light reflective portion 1129 and the high light blocking portion 1130 are integrally fixed to each other with a frame fixing member 39 therebetween.

### Thirteenth Embodiment

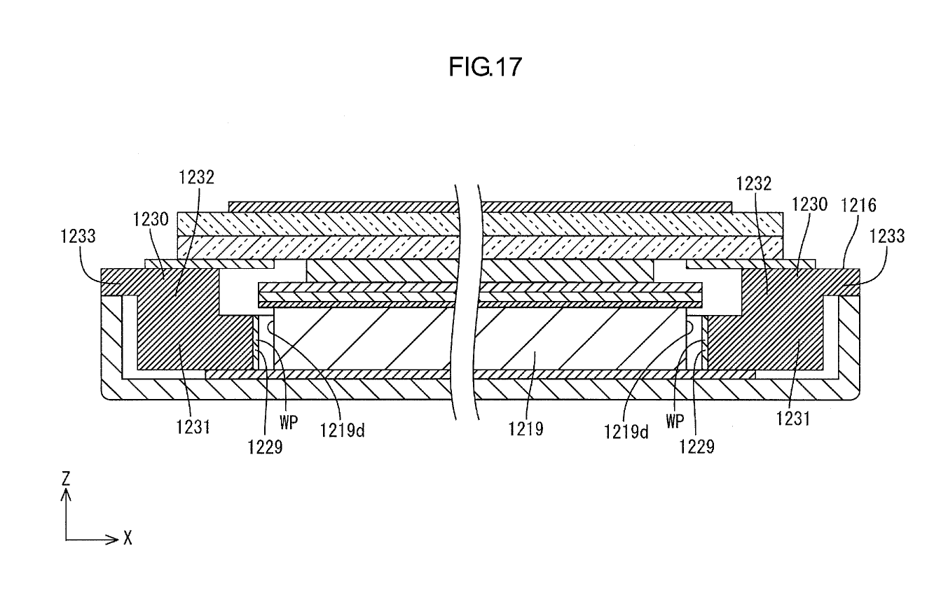

A thirteenth embodiment of this invention will be described with reference to FIG. 17. A frame 1216 of the thirteenth embodiment is different from the one in the first embodiment in that a paint WP is applied to a surface of the frame 1216 so as to provide a high light reflective portion 1229 and a high light blocking portion 1230. Other configurations are similar to the first embodiment and thus configurations, functions, and effects of those will not be described.

As illustrated in FIG. 17, the frame 1216 according to this embodiment is made of a black resin having light blocking and absorbing properties. The paint WP having a white color is applied to a portion of the frame 1216 except a small-width portion 1232 and a peripheral-wall overlapping portion 1233, that is, the paint WP is applied to a large-width portion 1231. Thus, the high light reflective portion 1229 and the high light blocking portion 1230 are formed. The paint WP is selectively applied to a portion of the large-width portion 1231 opposite to an LED non-opposing surface 1219d of a light guide plate 1219. With this configuration, the paint WP appropriately reflects rays of light that leaks through the LED non-opposing surfaces 1219d of the light guide plate 1219 back to the LED non-opposing surfaces 1219d by.

### Other Embodiments

The technology is not limited to the embodiments described in the above description and the drawings. For example, the following embodiments may be included in technical scopes of the technology.

(1) In the above embodiment, the large-width portion of the frame (the high light reflective portion) has the dimension in the Z-axis direction smaller than that of the light guide plate; however, the dimension of the large-width portion in the Z-axis direction may be the same or larger than that of the light guide plate.

(2) In the above embodiment, the small-width portion of the frame (the high light blocking portion) is higher in position in the Z-axis direction than the peripheral wall of the chassis; however, the small-width portion and the peripheral wall may be flush with each other in the Z-axis direction or the small-width portion may be lower in position in the Z-axis direction than the peripheral wall.

(3) In the above embodiment, the frame includes the large-width portion and the small-width portion; however, the frame may have substantially the same width over the height thereof.

(4) In the above embodiment, the inner surface of the high light reflective portion is flush with the LED non-arranged side surface of the optical sheet or closer to the LED non-opposing surface of the light guide plate than the LED non-arranged side surface of the optical sheet is. However, the inner surface of the high light reflective portion may be arranged on the outer side with respect to the LED non-arranged side surface of the optical sheet.

(5) In the above embodiment, the edge portions of the optical sheet protrude outward with respect to the respective LED non-opposing surfaces of the light guide plate; however, the LED non-arranged side surfaces of the optical sheet may be flush with the respective LED non-opposing surfaces or the LED non-arranged side surfaces of the optical sheet may be located inward with respect to the respective LED non-opposing surfaces.

(6) In the above embodiment, the high light blocking portion includes the peripheral-wall overlapping portions; however, the peripheral-wall overlapping portions can be omitted.

(7) Other than the above embodiments, the cross sections and the positions of the boundary surfaces of the high light reflective portion and high light blocking portion located therebetween in the Z-axis direction may be altered.

(8) Other than the above embodiments, specific planar shapes and sizes of the extending portions and the cut portions may be altered as appropriate.

(9) In the embodiments 2, 6, 11, and 12, the recess and the protrusion extend along the overall lengths of the high light reflective portions and the high light blocking portions, respectively; however, other than the above configuration, multiple recesses and protrusions may be arranged at intervals along the lengths of the high light reflective portions and the high light blocking portions, respectively.

(10) In the above embodiments, the high light reflective portion contains titanium oxide as a white colorant; however, zinc oxide, magnesium oxide, or aluminum oxide may be used as an alternative white colorant.

(11) In the above embodiments, the high light blocking portion contains carbon black as a black colorant; however, titanium black or ion black may be used as an alternative black colorant.

(12) In the above embodiments, the material having a white color is used for the high light reflective portion; however, materials having a milky color and a silver color may be used for the high light reflective portion.

(13) In the above embodiments, the material having a black color is used for the high light blocking portion; however, a material having a gray color may be used for the high light blocking portion.

(14) Other than the above embodiments, the physical properties and values of the high light reflective portion and the high light blocking portion may be altered as appropriate.

(15) In the above embodiments, the reflection sheet overlaps the frame from the rear in the Z-axis direction; however, the reflection sheet may not overlap the frame in the Z-axis direction.

(16) Other than the above embodiments, the frame may be fixed to the bottom plate of the chassis with a double-sided adhesive tape.

(17) In the above embodiments, the panel fixing member is fixed to the frame and the LED printed circuit board. However, the panel fixing member may be only fixed to the frame and not fixed to the LED printed circuit board. Alternatively, the panel fixing member may be omitted. In such a case, an adhesive agent (a preferable adhesive agent may be made of a photo curable resin) may be used instead of the panel fixing member.

(18) In the above embodiments, one of the short-side edges of the light guide plate facing the LEDs is the LED non-opposing surface (a light entrance surface). However, one of the long-side edges of the light guide plate may be the LED non-opposing surface (the light entrance surface) through which light from the LEDs enters the light guide plate. Other than the above configurations, two of the short-side edges of the light guide plate may be the LED non-opposing surfaces (the light entrance surface) through each of which light from the corresponding LEDs enters the light guide plate, or, two of the long-side edges of the light guide plate may be the LED non-opposing surfaces (the light entrance surfaces) through each of which light from the corresponding LEDs enters the light guide plate. Or else, three of the side surfaces of the light guide plate may be the LED non-opposing surfaces (the light entrance surfaces) through each of which light from the corresponding LEDs enters the light guide plate, or, all of the four side surfaces of the light guide plate may be the LED non-opposing surfaces (the light entrance surfaces) through each of which light from the corresponding LEDs enters the light guide plate.

(19) In the above embodiments, the LED printed circuit board includes a film-shaped base member; however, the base member of the LED printed circuit board may be a board having a certain thickness.

(20) In the above embodiments, the printed circuit board is an LED printed circuit board including LEDs; however, other types of printed circuit board including other types of light sources such as organic ELs may be used.

(21) In the above embodiments, the liquid crystal display device is used in portable information terminals such as smart phones or tablet-type personal computers. However, the liquid crystal display device may be used in in-vehicle information terminals (e.g., portable car navigation systems) and portable video game players.

(22) In the above embodiments, the color portions of the color filtered in the liquid crystal panel are in three colors of R, G, and B. However, the color portions may be provided in four or more colors.

(23) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(24) In the thirteenth embodiment, a white paint is applied to a portion of the surface of the frame (the large-width portion) which is made of a black resin so that the high light reflective portion and the high light blocking portion are provided; however, the frame may be made of a white resin and a black paint may be applied to a portion of the surface of the frame (the small-width portion and the peripheral wall overlapping portion) to provide the high light reflective portion and the high light blocking portion. Alternatively, the frame may be made of a resin having a color other than white and black. A black paint may be applied to a portion of the surface of the frame (the small-width portion and the peripheral wall overlapping portion) and a white paint may be applied to the other portion of the surface of the frame (the large-width portion). When the black paint is used, it is preferable to apply the black paint to at least portions of the small-width portion and the peripheral-wall overlapping portion opposite the liquid crystal panel and the optical sheet. It is also preferable to apply the black paint to the outer surfaces of the small-width portion and the peripheral-wall overlapping portion. Areas in the frame to which the respective paints are applied may be altered as appropriate.

(25) In the thirteenth embodiment and the embodiment in (24), a paint is applied to a portion of the surface of the frame that is made of a resin so that the high light reflective portion and the high light blocking portion are provided; however, a film having a colorant thereon may be attached to the surface of the frame by hot stamping (thermal printing). Other methods to apply specific colors on the surface of the frame may be altered as appropriate.

### EXPLANATION OF SYMBOLS

10: liquid crystal display device (display device), 11: liquid crystal panel (display panel), 12: backlight device (lighting device), 15: chassis, 15a: bottom plate, 15b: peripheral wall, 16, 316, 716, 816, 1016, 1216: frame, 16a: LED board supporting portion (light source supporting portion), 17: LED (light source), 18, 218, 418: LED printed circuit board (light source board), 19, 719, 819, 919, 1219: light guide plate, 19a: LED opposing surface (light source opposing surface), 19b, 719b: light exit surface, 19c: opposite plate surface, 19d, 919d, 1219d: LED non-opposing surface (light source non-opposing surface), 20, 720, 920: optical sheet, 20a, 920a: LED non-arranged side surface (end surface), 29, 129, 529, 629, 729, 829, 929, 1029, 1129, 1229: high light reflection portion, 29b, 929b: inner surface (opposite surface), 30, 130, 230, 430, 530, 630, 730, 830, 1030, 1130, 1230: high light blocking portion, 31, 731, 831, 1231: large-width portion, 32, 732, 832, 1232: small-width portion, 33: the peripheral-wall overlapping portion, 34, 234, 334, 434: extending portion, 35, 235, 435: cur portion, C: gap.

1. A lighting device comprising:
a light source;
a light guide plate including peripheral surfaces and plate surfaces, one of the peripheral surfaces being a light source opposing surface that is opposed to the light source and through which light from the light source enters the light guide plate, another one of the peripheral surfaces being a light source non-opposing surface that is not opposed to the light source, one of the plate surfaces being a light exit surface through which light exits the light guide plate, and another one of the plate surfaces being an opposite plate surface on an opposite side from the light exit surface; and
a frame having a frame-like shape, surrounding the light guide plate, the frame including a high light reflective portion and a high light blocking portion, the high light reflective portion being opposite at least the light source non-opposing surface of the light guide plate, the high light blocking portion being arranged at an end of the high light reflective portion in a direction parallel to a direction from the light exit surface to the opposite plate surface along a normal direction that is normal to one of the plate surfaces of the light guide plate, the high light blocking portion having a light reflectivity lower than that of the high light reflective portion and a light blocking property higher than that of the high light reflective portion.

2. The lighting device according to claim 1, further comprising an optical sheet including a plate surface that extends along the plate surfaces of the light guide plate and faces the light exit surface of the light guide plate, wherein
the high light blocking portion has a light absorbing property higher than the high light reflective portion, and
the high light blocking portion is arranged such that at least a portion of a surface thereof along the normal direction normal to the plate surfaces of the light guide plate is opposed to a peripheral surface of the optical sheet.

3. The lighting device according to claim 2, wherein the high light reflective portion includes an opposite surface that is opposite the light source non-opposing surface of the light guide plate, the high light reflective portion being arranged such that the opposite surface thereof is flush with the peripheral surface of the optical sheet or closer to the light source non-opposing surface of the light guide plate relative to the peripheral surface of the optical sheet.

4. The lighting device according to claim 1, further comprising a chassis for holding the light source, the light guide plate, and the frame therein, the chassis including at least a bottom plate and a peripheral wall, the bottom plate extending along the plate surfaces of the light guide plate, the peripheral wall extending upward from an edge of the bottom plate and surrounding the frame, wherein
the high light reflective portion includes a peripheral-wall overlapping portion disposed on an end of the peripheral wall in the direction parallel to a direction from the opposite plate surface to the light exit surface along the normal direction normal to the plate surfaces of the light guide plate.

5. The lighting device according to claim 1, wherein the high light reflective portion is arranged such that at least a portion of a surface thereof along the normal direction that is normal to the plate surfaces of the light guide plate is opposed to the light source.

6. The lighting device according to claim 1, wherein the high light reflective portion is arranged such that an entire area of a surface thereof along the normal direction normal to the plate surfaces of the light guide plate is opposed to the light source non-opposing surface.

7. The lighting device according to claim 1, wherein the high light reflective portion and the high light blocking portion of the frame are integrally formed by dual-color molding.

8. The lighting device according to claim 7, wherein the frame includes a large-width portion having a relatively large width and a small-width portion having a relatively small width, the small-width portion being on an end of the large-width portion in the direction parallel to the direction from the opposite surface to the light exit surface along the normal direction normal to the plate surfaces of the light guide plate, wherein the large-width portion constitutes the high light reflective portion and the small-width portion constitutes the high light blocking portion.

9. The lighting device according to claim 8, wherein the large-width portion is closer to the light source non-opposing surface of the light guide plate relative to the small-width portion.

10. The lighting device according to claim 1, further comprising a light source board on which the light source is mounted, the light source board being arranged such that at least a portion of a surface thereof along the normal direction normal to the plate surfaces of the light guide plate is opposed to the high light blocking portion with space between the light source board and the high light blocking portion, wherein
a light source supporting portion for supporting at least a portion of an end of the light source board in the direction parallel to the direction from the light exit surface to the opposite plate surface along the normal direction normal to the plate surfaces of the light guide plate, the light source supporting portion being along the light source opposing surface,
the high light blocking portion of the frame adjacent to the light source opposing surface includes an extending portion extending toward the light source board supporting portion, the high light blocking portion extending along the light source non-opposing surface, and
the light source board includes a cut portion to receive the extending portion.

11. The lighting device according to claim 10, wherein the extending portion and the cut portion are formed such that edges thereof adjacent to each other are oblique when viewed in the normal direction normal to the plate surface of the light guide plate.

12. A display device comprising:
the lighting device according to claim 1; and
a display panel configured to display an image using light from the lighting device.

13. The display device according to claim 12, wherein the high light blocking portion of the frame is adjacent to a surface of the display panel facing the light guide plate and supports the display panel therefrom.

14. The display panel according to claim 12, wherein the display panel is a liquid crystal panel including liquid crystals.
